(19) United States
(12) Patent Application Publication
(10) Pub. No.: US 2026/0244859 A1
(43) Pub. Date: Aug. 20, 2026

(54) LIVE CONVERSATION INFORMATION RETRIEVAL VIA CONTEXT TOKENS AND REAL-TIME NATURAL LANGUAGE UTTERANCES SYSTEMS AND METHODS

(71) Applicant: Capital One Services, LLC, McLean, VA (US)

(72) Inventors: Yuhui Tang, Fairfax, VA (US); Jing Zhu, Fairfax, VA (US); Youbing Yin, Bellevue, WA (US); Jingyu Wu, Jersey City, NJ (US); Vivek Datla, Ashland, MA (US); Zhiqi Huang, Cambridge, MA (US); Alfy Samuel, White Plains, NY (US); Daben Liu, Belmont, MA (US)

(73) Assignee: Capital One Services, LLC, McLean, VA (US)

(21) Appl. No.: 19/054,606

(22) Filed: Feb. 14, 2025

(51) Int. Cl. G06F 40/284; G06F 16/332; G06F 16/383

(52) U.S. Cl. CPC G06F 40/284; G06F 16/3328; G06F 16/383

(57) ABSTRACT

Methods and systems are described herein for improving information retrieval during a live conversation via context tokens and real-time natural language utterances. For example, the system may receive a first set of decrypted utterances spoken during a live conversation. The system may determine a token comprising token data associated with a second set of decrypted utterances spoken during the live conversation prior to the first set of decrypted utterances. The system may generate, via a secured model, a first query and a subset of utterances corresponding to the first set of utterances and the token data. The system may perform a first search based on the first query and a second search based on the subset of utterances to retrieve a set of relevant computer files. The system may generate, during the live conversation, a graphical representation of the set of relevant computer files.

### BACKGROUND

In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, data that is obtained may need to be categorized and labeled accurately, which can be difficult, time-consuming and a manual task. Second, despite the mainstream popularity of artificial intelligence, practical implementations of artificial intelligence may require specialized knowledge to design, program, and integrate artificial intelligence-based solutions, which can limit the amount of people and resources available to create these practical implementations. Finally, results based on artificial intelligence can be difficult to review as the process by which the results are made may be unknown or obscured. This obscurity can create hurdles for identifying errors in the results, as well as improving the models providing the results. These technical problems may present an inherent problem with attempting to use an artificial intelligence-based solution in retrieving relevant information based on a live conversation.

### SUMMARY

Methods and systems are described herein for novel uses and/or improvements to real-time conversation information retrieval. As one example, methods and systems are described herein for improving information retrieval during a live conversation via context tokens and real-time natural language utterances.

Existing systems encounter several technical challenges when retrieving relevant documents during live conversations. A primary issue is the ability to obtain contextually and semantically accurate information to aid a problem faced by a user discussed during the conversation. While many systems utilize Large Language Models (LLMs) within a Retrieval-Augmented Generation (RAG) framework to generate responses based on conversation transcripts, this approach introduces its own complexities. Specifically, these systems require specialized vector databases optimized for high-dimensional data storage and retrieval. The preprocessing of these databases to create accurate file embeddings is computationally intensive and necessitates manual verification of accuracy, which can hinder efficiency.

Moreover, integrating these databases with LLMs is essential for real-time information access but complicates system architecture. If the integration is not seamless, the model may struggle to produce contextually relevant responses. Additionally, while LLMs generate answers based on retrieved information, they are prone to producing hallucinated responses—outputs that are coherent yet factually incorrect. Although RAG frameworks can mitigate some instances of hallucination, the inherent nature of LLMs still leaves them vulnerable to generating or retrieving inaccurate information, which can negatively impact user experience by presenting counter-productive information not relevant to the user's problem.

Finally, maintaining the context of earlier utterances while addressing current user queries presents another significant challenge. As conversations evolve, ensuring contextual continuity is crucial for retrieving relevant information. LLMs utilize context windows to preserve context of earlier dialogue, but these are limited by memory constraints, restricting the amount of prior context that can be retained. While prompting the LLM to reference earlier parts of the conversation is available, such prompting requires explicit instructions, which are impractical in dynamic, real-time interactions. As participants engaging in the conversation must balance interacting with each other while also attempting to find relevant information, the additional step of providing the LLM explicit instructions during the conversation may cause confusion among the participants or cause important information discussed to be missed or looked over as a user's attention shifts from the conversation, to attempting to instruct the LLM to provide relevant information.

To overcome the technical disadvantages of these existing systems, methods and systems described herein improve information retrieval accuracy during a live conversation by using a unique architecture that performs bifurcated database searches based on respective, secure model generated, queries and subsets of utterances that leverages historical context tokens and current utterances spoke during the conversation. For example, such methods and systems allow for relevant computer files to be displayed to a user during a conversation that pertains to the conversation as whole while reducing the document retrieval inaccuracies stemming from hallucinated responses—thereby enhancing the user experience when solving problems discussed during the live conversation by providing relevant supplemental information.

In some embodiments, the system may receive, during live conversation, a first set of decrypted utterances spoken during the live conversation. The system may additionally determine a token including token data associated with a second set of decrypted utterances spoken during the live conversation prior to the first set of decrypted utterances. For example, the system may determine a token that includes a compressed representation of historical utterances spoken during the live conversation to preserve contextual information related to the conversation. By doing so, the system may overcome context window limitations associated with existing systems by retrieving tokenized representations of historical utterances to supplement topics or ideas currently being discussed during the live conversation.

The system may then provide both the first set of decrypted utterances (e.g., indicated the latest topics discussed during the conversation) and the token data (e.g., indicating the historical context of topics previously discussed during the conversation) as input to a secured model to generate (i) a query and (ii) a subset of utterances. For example, the system may provide the first set of decrypted utterances and the token data to a LLM to generate the query and a set of filtered utterances to be used in performing a bifurcated search (e.g., a semantic search and a lexical search, respectively). By doing so, the system not only preserves the context of the conversation as a whole, but also forgoes the reliance of traditional systems implementing LLMs within RAG frameworks—necessitating specialized vector databases optimized for high-dimensional data. As such, the system may instead leverage preexisting databases to be searched to retrieve relevant documents, thereby streamlining the retrieval process and ensuring timely access to information.

The system may then perform the bifurcated search during the live conversation to obtain bifurcated search results (e.g., based on the query, and subset of utterances, respectively) indicating a set of relevant computer files to be presented to one or more users (e.g., participants) of the live conversation. By doing so minimizes the risk of LLM-derived hallucinations, which can mislead users by producing coherent but factually incorrect outputs. For example, as opposed to the LLM integrated RAG frameworks of existing systems discussed above, the secured model (e.g., the LLM) is implemented as support to the system, generating queries and keywords that guide the search process while relying on established data for retrieval. This approach mitigates factual inaccuracies, as the LLM does not independently generate answers but instead focuses on facilitating effective searches. This in turn enhances the user experience by providing immediate access to contextually relevant documents during the live conversation. Such capability improves problem-solving and decision-making in dynamic interactions, ensuring that users receive accurate and timely information as the conversation progresses.

In some aspects, methods and systems for improving information retrieval during a live conversation via context tokens and real-time natural language utterances are described. For example, the system may receive, during a live conversation over a computer network, a first set of decrypted utterances spoken during the live conversation. The system may determine, from a token vault database, a token including token data associated with a second set of decrypted utterances spoken during the live conversation prior to the first set of decrypted utterances being received. The system may provide (i) the first set of decrypted utterances and (ii) the token data as input to a secured model, trained to generate first outputs indicating queries and second outputs indicating subsets of natural language utterances. In response to providing the first set of decrypted utterances as input to the secured model, the system may generate, via the secured model, (i) a first query corresponding to both the first set of decrypted utterances and the token data and (ii) a subset of utterances corresponding to the first set of decrypted utterances and the token data. The system may perform, during the live conversation, (i) a first search using the first query on a first database and (ii) a second search using the subset of utterances on a second database to retrieve a set of relevant computer files based on the first search and the second search. The system may generate, for display, on a user interface of a user device, during the live conversation, a graphical representation of the set of relevant computer files.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram of a live conversation, in accordance with one or more embodiments.

FIG. 2 shows an illustrative diagram of a user interface associated with a live conversation, in accordance with one or more embodiments.

FIG. 3 shows illustrative components for a system used to facilitate information retrieval during a live conversation, in accordance with one or more embodiments.

FIG. 4 shows an illustrative diagram of an artificial intelligence model used to facilitate one or more operations, in accordance with one or more embodiments.

FIG. 5 shows a flowchart of the steps involved in improving information retrieval during a live conversation via context tokens and real-time natural language utterances, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

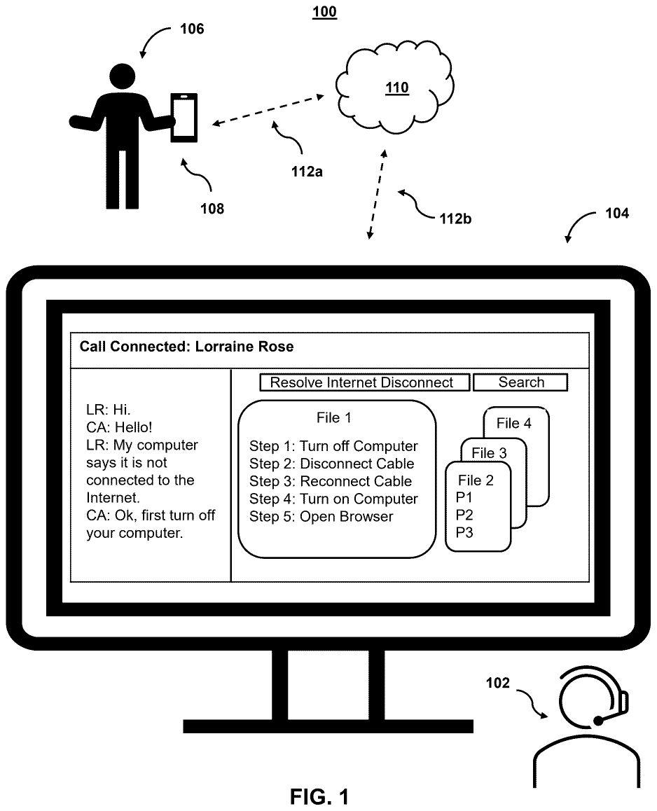

FIG. 1 shows an illustrative diagram of a live conversation, in accordance with one or more embodiments. For example, environment 100 shows a first user 102 engaging in a live (e.g., real-time) conversation with a second user 106. The first user 102 may engage in the live conversation via first user device 104 and the second user 106 may engage in the live conversation via second user device 108. First user device 104 and second user device 108 may communicate with each other over network 110 using communication links 112a-112b. For example, communication links 112a-112b may include wired or wireless communication paths, such as a satellite path, a fiber-optic path, a cable path, a path that supports Internet or Intranet communication, free-space connections (e.g., for broadcast or other wireless signals), or any other suitable wired or wireless communication path or combination of communication paths. Additionally, each of the components of environment 100 may include hardware/software that enable communication among communication links 112a-112b.

The live conversation may refer to a real-time conversation, such as a conversation involving an exchange of information between two or more users (e.g., people) where audio, text, or video are communicated between the two or more users in an ongoing, continuous manner, where such information is exchanged and delivered while the conversation is active. For example, the live conversation may be in various formats such as an audio format (e.g., a telephone conversation, VoIP conversation, etc.), a text format (e.g., text-based conversation, instant messengers, chat rooms, etc.), video format (e.g., video conferencing, live-streaming, etc.) or any combination thereof. A live conversation may be a current conversation that two or more users are currently involved in. For example, as opposed to a pre-recorded conversation, a live conversation may include instances where new information (e.g., data) is currently being transmitted (e.g., the conversation has not terminated or inactive).

In a customer service embodiment, the first user 102 may be a customer service agent and the second user 106 may be a customer. The customer service agent and the customer may engage in a live conversation over a communication network (e.g., network 110). The customer may inquire about a given scenario that the customer is currently experiencing. For example, the customer may look for help regarding how to reconnect to the Internet, to change user account information associated with the user, to check a current bank account balance, to update Personally Identifiable Information (PII) associated with the customers account, or other inquiry. For instance, in a customer service embodiment relating to a financial services, the customer may ask the customer service agent questions or provide statements to the customer service agent regarding servicing a financial account associated with the user, resolving issues related to one or more payments, resolving issues related to accessing their account via a mobile application associated with a respective financial service provider, or other financial service-related scenarios. While the customer service agent may specialize in aiding customers with such inquiries, the customer service agent must not only be attentive to the conversation to avoid a negative customer impression, but also be able to quickly locate supporting documents to help the customer. To locate supporting documents, the customer service agent may search one or more databases to locate relevant files to help the customer. However, locating supporting documents may be challenging. For instance, because the customer service agent is currently engaged in a conversation, the customer service agent may become distracted when attempting to formulate effective search queries to locate supporting files or documents. Additionally or alternatively, even if the customer service agent knows what type of document to look for, the customer service agent may be prone to generating incoherent search queries that may not result in effective search results being generated. Lastly, if multiple documents are discovered, the customer service agent must still parse through all the available documents to find those most pertinent to the customer's inquiry. Each of these difficulties may result in a poor customer experience as time may be wasted, and a large amount of computational resources may be wasted (e.g., due to a large amount of queries being submitted to a variety of databases to find relevant documents).

The system may use utterances to facilitate information retrieval. In disclosed embodiments, an utterance may include a unit of communication or expression. In some embodiments, an utterance may comprise spoken words. In some embodiments, an utterance may comprise sounds. In some embodiments, an utterance may comprise non-verbal elements (e.g., portions of text). In some embodiments, an utterance may comprise verbal elements, such as an expression, phrase, or other sound produced by a speaker in a single instance or within a specific conversational context. In some embodiments, an utterance may comprise a segment of input data corresponding to a conversational turn or thought.

The system may use decrypted utterances to facilitate information retrieval. In disclosed embodiments, a decrypted utterance may include an utterance that is transformed from one state to another state. In some embodiments, a decrypted utterance may comprise an utterance that is decrypted from an encrypted state associated with a cryptographic communication protocol. In some embodiments, a decrypted utterance may comprise an utterance that is transcribed. For example, an audio utterance may be decrypted using an audio-to-text model or algorithm. In some embodiments, a decrypted utterance may comprise a text utterance that is transformed into an audio utterance. For example, to aid the visually impaired, the text utterance may be transformed into an audio utterance via a text-to-audio model or algorithm.

The system may use tokens to preserve conversational context during a conversation. In disclosed embodiments, a token may include a discrete unit of information used by one or more computing devices to process information associated with the token. In some embodiments, a token may comprise context of at least a portion of a conversation. In some embodiments, a token may comprise context of at least an utterance of a conversation. In some embodiments, a token may comprise context of one or more utterances of a conversation. In some embodiments, a token may comprise a conversation token. For example, a conversation token (or context token) may include information, derived from or representing elements or other parts of a conversation. For example, a context token may capture semantic, syntactic, or contextual details to facilitate understanding, processing, or continuation of the conversation. In some embodiments, a token may comprise a metadata token. For example, the metadata token may include user identifiers, timestamps, tone, or other information that does not include utterances themselves transmitted during the conversation. In some embodiments, a token may comprise special tokens that indicate conversational boundaries during the conversation (e.g., the end of a user's turn in speaking, the end of a user's turn when conveying a thought, the beginning or activation of the conversation, the end or termination of the conversation). In some embodiments, a token may comprise an embedding of one or more utterances during a conversation. In some embodiments, a token may comprise utterances part of the conversation. In some embodiments, a token may comprise a summarization of one or more utterances part of the conversation. In some embodiments, a token may comprise all of, or a portion of the information described above. In some embodiments, a token may be a combination of one or more of the tokens described above.

The system may use graphical representations of files to be presented to one or more users. In disclosed embodiments, a graphical representation may include a visual depiction of information, data, or content in a format interpretable by human users. In some embodiments, a graphical representation may include a visual display of a file (e.g., a document, a graph, a computer file, a log file, transcripts, etc.). In some embodiments, a graphical representation may include visual elements such as images, diagrams, charts, icons, or other visual elements. In some embodiments, a graphical representation may include a rendered object. For example, the files may include files related to computer errors (e.g., log files, resolutions to errors, help documents, network protocols, documentation files, etc.). As another example, the files may include service provider specific files. For instance, a financial service provider may store or otherwise have access to financial documents such as bank account documents, loan documents, payment information, mobile application documents related to a financial service application, help documents, tax forms, transaction dispute forms, insurance policies, investment reports, financial account statements, customer correspondences, PII of customer accounts, or other financial documents. Such files (or other documents) may be retrieved and displayed during the live conversation based on one or more utterances communicated during the live conversation.

The system may use a user interface to display graphical representations (e.g., of files, documents, or other content) or enable users to interact with one or more system components. In disclosed embodiments, a user interface may include hardware/software components to facilitate a human-computer interaction and communication in a device, and may include display screens, keyboards, a mouse, and the appearance of a desktop. For example, a user interface may comprise a way a user interacts with an application or a website. In some embodiments, a user interface may facilitate a presentation or other display of graphical representations (or other elements). In some embodiments, a user interface may be a visual interface, an audio interface, or physical interface that enables a user to view or interact with one or more elements/components.

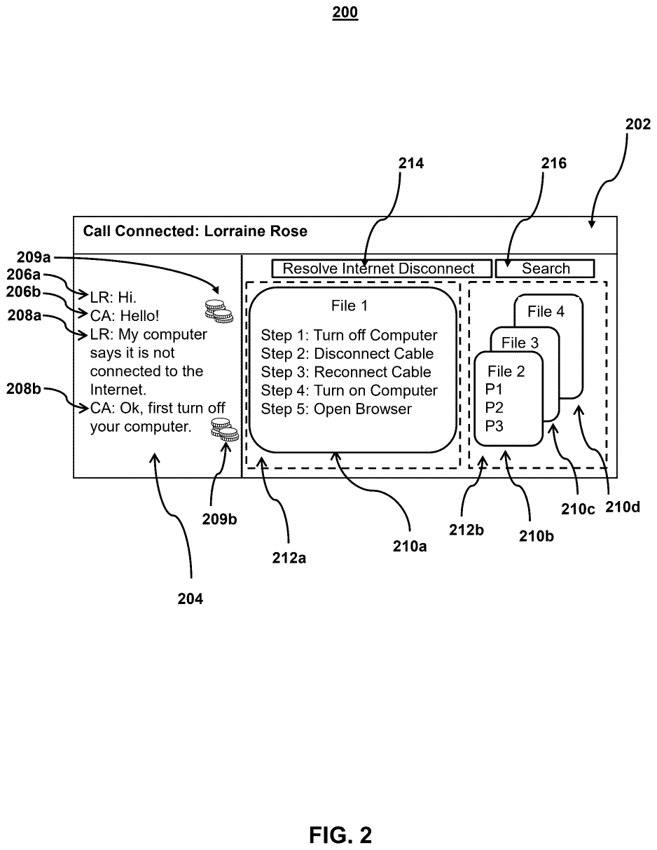

FIG. 2 shows an illustrative diagram of a user interface associated with a live conversation, in accordance with one or more embodiments. For example, user interface 200 shows an illustrative user interface presented to a user during a live conversation 202. User interface 200 may include a transcript 204 of the live conversation 202, a first set of decrypted utterances 206a-206b, a second set of decrypted utterances 208a-208b, tokens 209a-209b, a set of computer files 210a-210d, presentation regions 212a-212b, a search term 214, and a search button 216. Transcript 204 may be a transcript that is generated based on the live conversation 202. For example, the transcript may include decrypted utterances spoken by first user 102 and second user 106, transmitted between first user device 104 and second user device 108 (FIG. 1). As an example, a customer service agent may engage in a live conversation with a customer. As the live conversation progresses, the system may generate a transcript of utterances spoken during the live conversation. For example, in a computer-error embodiment, the live conversation may include words, phrases, or other utterances related to resolving an Internet disconnection issue. The customer and the customer service agent may converse with each other where the customer provides information (e.g., statements, queries, words, phrases, or other utterances) to the customer service agent indicating the Internet disconnect issue the customer is currently facing. In a financial services embodiment, however, the live conversation may be related to resolving a mobile application issue provided by a financial service provider. For example, the mobile application may be failing to enable the user access to the user's financial account. As another example, the live conversation may be related to resolving a misappropriated payment, servicing a loan associated with the customer, changing one or more financial account privileges, updating PII associated with the user's financial account, or other scenarios where the customer is seeking help or additional information related to financial scenarios.

The system may display the transcript of utterances on user interface 200 to enable the customer service agent to view what has been discussed during their live conversation to serve as reference information to locate one or more computer files. However, it should be noted, the user interface 200 may not merely be displayed to just the first user 102 (e.g., a customer service agent) but may also be displayed to the second user 106 (e.g., the customer). By doing so, the customer may also be able to view computer files, in accordance with one or more embodiments.

In some embodiments, the transcript 204 may include sets of decrypted utterances. For example, transcript 204 may include first set of decrypted utterances 206a-206b and second set of decrypted utterances 208a-208b. The first set of decrypted utterances 206a-206b and the second set of decrypted utterances 208a-208b, may each have portions of utterances. For example, the first set of decrypted utterances 206a-206b may be formed by a first portion of decrypted utterances 206a (e.g., “Hi”), and a second portion of decrypted utterances 206b (e.g., “Hello”). Likewise, the second set of decrypted utterances 208a-208b may be formed by a third portion of decrypted utterances 208a (e.g., “My,” “computer,” “says,” “it,” “is,” “not,” “connected,” “to,” “the,” “Internet.”) and a fourth portion of decrypted utterances 208b (e.g., “Ok,” “first,” “turn,” “off,” “your,” “computer.”). In some embodiments, the respective portions of utterances may correspond to a respective user. For example, the first portion of decrypted utterances 206a and the third portion of decrypted utterances 208a may correspond to second user 106 (FIG. 1). As another example, the second portion of decrypted utterances 206b and the fourth portion of decrypted utterances 208b may correspond to first user 102 (FIG. 1).

In a financial services embodiment, however, the first set of decrypted utterances 206a-206b and the second set of decrypted utterances 208a-208b may include utterances related to a financial service account of a customer (or other financial service-related utterances). For example, the second user 106 (FIG. 1) may be a customer that has an account provided by an entity (e.g., financial service provider) and the first user 102 may be a customer service agent that is associated with the entity to offer help or assist the customer. As such, the customer may converse with the customer service agent regarding fraudulent activity that the customer noticed. In such a case, first portion of decrypted utterances 206a may indicate “Hi”, and a second portion of decrypted utterances 206b may indicate “Hello.” Likewise, a third portion of decrypted utterances 208a may indicate “I,” “noticed,” “a,” “payment,” “that,” “I,” “did,” “not,” “make” and a fourth portion of decrypted utterances 208b may indicate “Ok,” “let,” “me,” “help,” “you.”

The first set of decrypted utterances 206a-206b may indicate utterances that have occurred earlier than that of second set of decrypted utterances 208a-208b. As such, the first set of decrypted utterances 206a-206b may indicate historical utterances communicated during the live conversation 202, and the second set of decrypted utterances 208a-208b may indicate current utterances being communicated during the live conversation 202. The first set of decrypted utterances 206a-206b may be utterances spoken during a first time period of the live conversation 202, and the second set of decrypted utterances 206a-206b may be utterances spoken during a second time period of the live conversation 202. In some embodiments, the first time period may be earlier than that of the second time period with no overlap between the time periods. In some embodiments, the second time period may overlap a threshold amount of time with the first time period. By doing so, as will be explained later, the system may generate a token indicating utterance information of sets of utterances with respect to the time at which such utterances were communicated for later use to preserve contextual information of the live conversation when determining relevant files for the live conversation.

In some embodiments, the system may decrypt an encrypted set of utterances to generate the sets of decrypted utterances. For example, to enhance security of the live conversation 202, prior to, or during the live conversation 202 being activated, the system may cause an exchange of cryptographic keys associated with the user devices that are associated with the live conversation 202 to be performed to encrypt information (e.g., utterances or other data) passed between the user devices. For instance, prior to the live conversation 202 being activated, the system may cause the first user device 104 and the second user device 108 to exchange cryptographic keys to enable encrypted communication between the user devices. The cryptographic keys may be public keys (e.g., for asymmetric encryption) or private keys (e.g., for symmetric encryption). The encrypted communication may be in accordance with a cryptographic communication protocol, such as TLS/SSL, IPsec, PGP, SSH, Signal Protocol, Diffie-Hellman Key Exchange. The encrypted communication between the user devices may be based on an encryption algorithm such as AES, 3DES, RSA, EEC, or other encryption algorithms.

For example, in some embodiments, when the live conversation 202 is activated (e.g., begins, starts, etc.), the system may receive from a user device, a first set of encrypted utterances. Prior to receiving the first set of encrypted utterances, the user device may perform a cryptographic key exchange with another user device that is involved in the live conversation 202 to enable secure, encrypted communication between the user devices. For example, first user device 104 and second user device 108 may perform a cryptographic key exchange (e.g., a public key exchange associated with asymmetric encryption, a private key exchange for symmetric encryption) associated with a cryptographic communication protocol. By doing so, the system may enhance cybersecurity of the live conversation by facilitating secure communication between the user devices.

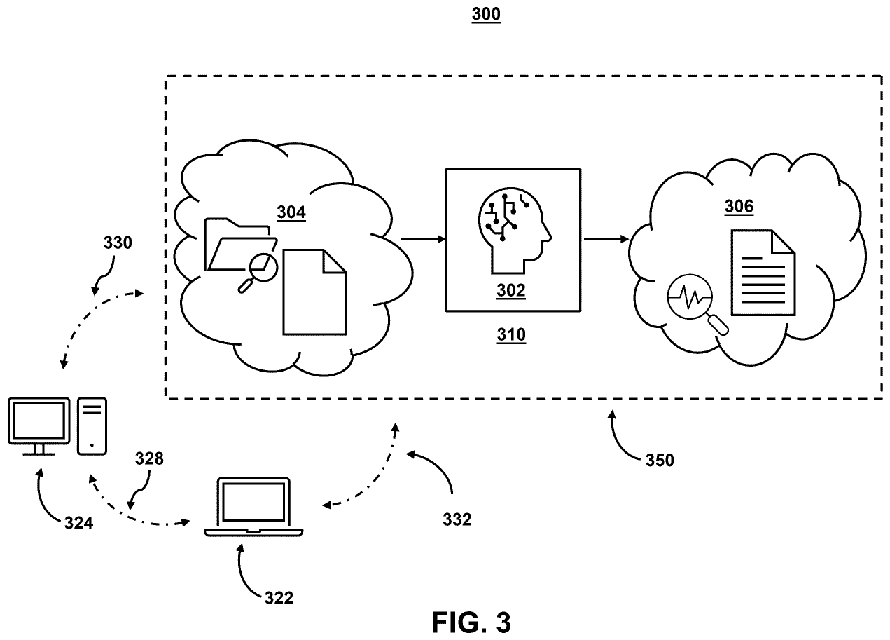

In some embodiments, the system may receive the first set of encrypted utterances, where the first set of encrypted utterances are encrypted via an encryption protocol using a public key associated with the second user device. For example, the system may receive, via the network 110, a first set of encrypted utterances from the second user device 108, where the first set of encrypted utterances is encrypted using the public key associated with the first user device 104 (FIG. 1). The system may then decrypt the first set of encrypted utterances via a private key associated with the first user device 104. For example, the first user device 104 may receive the set of encrypted utterances from second user device 108. The system may generate the first set of decrypted utterances based on (i) the first set of encrypted utterances and (ii) a second set of decrypted utterances by decrypting the first set of encrypted utterances via a private key associated with the first user device 104. For example, as the second user device 108 may transmit a set of encrypted utterances, the system may generate the first set of decrypted utterances by (i) decrypting the set of encrypted utterances (e.g., received from the second user device 108, such as the encrypted utterances corresponding to the first portion of decrypted utterances 206a) and (ii) adding a second set of decrypted utterances (e.g., utterances spoken by or transmitted from first user device 104, such as the second portion of decrypted utterances 206b) to the decrypted set of encrypted utterances (e.g., received from the first user device 104). That is, because the first user 102 may be part of the associated with an entity controlling system 300 (FIG. 3), it may be redundant to encrypt the utterances spoken by the first user device 104 for determining a relevant set of computer files. While the system may encrypt utterances by the first user 102 for transmission to the second user device 108 to enhance cybersecurity, the system may maintain the unencrypted (e.g., decrypted) form of utterances by the first user 102 for use in determining a relevant set of computer files associated with the live conversation 202—thereby decreasing the amount of computational resources that would otherwise be wasted by encrypting a set of utterances to then be decrypted for processing. As an example, the system may generate the first set of decrypted utterances 206a-206b based on (i) decrypting a portion of the encrypted utterances received from the second user device 108 and (ii) adding a portion of decrypted utterances to be transmitted from the first user device 104 together to form the first set of decrypted utterances 206a-206b.

In some embodiments, the first set of decrypted utterances may be generated based on a secured model. For example, the system may receive, during the live conversation 202, a first set of encrypted utterances from second user device 108. In such an example, the first set of encrypted utterances may be encrypted according to an encryption protocol. In such an example, the encryption protocol may refer to a format of the utterances (e.g., an audio format). To determine a relevant set of computer files associated with the live conversation 202, the system may decrypt the first set of encrypted utterances into a textual format. For example, the system may use a second secured model (e.g., an audio-to-text model) implemented in a secured computing environment of system 300. The second secured model (e.g., the audio-to-text model) may be an automatic speech recognition model, sequence-to-sequence model, neural network, transformer-based model, or other artificial intelligence model configured to receive data representing audio as input and output data representing text as output. The system may generate the first set of decrypted utterances based at least in part on providing the first set of encrypted utterances into the second secured model. For example, the system may provide the first portion of encrypted utterances (e.g., utterances received from the second user device 108) to the second secured model trained to decrypt encrypted utterances (e.g., convert, translate, or transcribe audio utterances, etc.), where the second secured model generates a portion of decrypted utterances (e.g., first portion of decrypted utterances 206a) as output. The system may then combine the first portion of decrypted utterances 206a with a second utterances (e.g., second portion of decrypted utterances 206b) to form the first set of decrypted utterances 206a-206b. For example, the second utterances may be utterances from the first user 102 that are originally in an audio format, but then decrypted by the system (e.g., using the second secured model) to enable display of the first set of decrypted utterances on user interface 200. In other words, the system may employ the audio-to-text model to generate the first set of decrypted utterances 206a-206, the second set of decrypted utterances 208a-208b to generate transcript 204 for (i) display on user interface 200, and (ii) use in determining a set of relevant computer files associated with the live conversation 202.

It should be noted that, while the generation of the first set of utterances are described above, the same or similar processes may be applied to the second set of utterances. For example, as the live conversation 202 progresses in time and new data is received (e.g., subsequent sets of utterance-related data), the system may generate new sets of decrypted utterances for display on user interface 200 and for use in determining a set of relevant computer files associated with the live conversation. As such, transcript 204 may become larger in size and incorporate textual versions of utterances spoken by first user 102 and second user 106 as the live conversation 202 progresses in time.

In some embodiments, the system may extract sets of utterances from a super set of utterances. For example, in some embodiments, the first set of decrypted utterances 206a-206b and the second set of decrypted utterances 208a-208b may form a superset of utterances. As the live conversation 202 progresses in time, the system may focus on a subset of the superset of utterances. For example, the system may determine based on the superset of utterances, a portion of the superset of utterances that are associated with a first user identifier and a second portion of the superset of utterances that are associated with a second user identifier. To reduce utilization of computational resources when determining relevant computer files to the live conversation, the system extracts portions of the superset of utterances. For example, the system may extract only utterances that a given user (e.g., a customer) has provided during the live conversation. By doing so, the system may avoid convoluting the underlying context during the live conversation with the customer service agent's input—thereby focusing on determining relevant computer files related to the customers inquiries during the conversation. As such, the system may extract a set of utterances (e.g. set of decrypted utterances) associated with the customer (e.g., second user 106), such as first portion of decrypted utterances 206a and third portion of decrypted utterances 208a.

In some embodiments, the system may generate tokens associated with the live conversion. For example, as the live conversation 202 progresses, the system may generate tokens 209a-209b to preserve context of the live conversation 202 for use in determining sets of computer files relevant to live conversation 202. Tokens 209a-209b may be any of the tokens described above. For example, first token 209a and second token 209b may be a context token (e.g., a token comprising context of at least an utterance of a conversation). Tokens 209a-209b may be generated during the live conversation 202 and may be stored in a token vault database for later retrieval/use. The token vault database (not shown) may be part of system 300 (FIG. 3). Token vault database may store tokens that may be searched for, retrieved, or otherwise accessed during the live conversation.

Tokens 209a-209b may include information associated with the live conversation. For example, each token may include token data. The token data may indicate (i) a token identifier, (ii) a token timestamp, (iii) a set of decrypted utterances, or other information, in accordance with one or more embodiments. A token identifier may be a value (e.g., alphanumeric, numeric, string, set of characters, etc.) that uniquely identifies a token. The token timestamp may be a timestamp indicating a time at which the token is generated. In some embodiments, the token timestamp may indicate a time associated with a set of utterances. The token data may additionally indicate a set of decrypted utterances. For example, the token data may include an embedding of a set of utterances part of transcript 204. As an example, the system may generate an embedding representing the first portion of decrypted utterances 206a and second portion of decrypted utterances and store the embedding as part of (or in association with a given token). In some embodiments, the embedding may represent a compressed version of information included in a set of utterances. For example, in a financial services embodiment, the embedding may indicate financial information discussed up until the token is generated (or between generated tokens), a loan or payment discrepancy, an indication of fraud, accessing a customer's financial account, supporting statements, resolutions to a given problem the customer is facing, helpful information for resolving a problem the customer is facing, prior solutions to a problem the user is facing, or other financial services-related information. By doing so, the system may reduce the amount of computer memory utilized when storing tokens as the tokens may include embeddings of one or more utterances. In some embodiments, the system may store a pointer indicating a set of utterances. For example, the system may store a pointer (e.g., a memory pointer) in the token that points to a memory location (e.g., address) storing the corresponding utterances. By doing so, the system may reduce the amount of computer processing power used to preserve context by foregoing the generation of an embedding of the set of utterances. Additionally or alternatively, the system may store a representation of the utterances themselves in the token (e.g., as part of the token data).

In some embodiments, during a live conversation (e.g., live conversation 202), the system may receive a first set of decrypted utterances (e.g., natural language utterances) spoken within a first time period of the live conversation. For example, first user 102 may converse with second user 106 via first user device 104 and second user device 108, respectively. The system may receive first set of decrypted utterances 206a-206b. The system may then generate a token (e.g., first token 209a) including the token data (e.g., as described above), which may include a unique identifier for the token, an embedding of the first set of decrypted utterances 206a-206b, and a timestamp indicating the time at which the token is generated. Additionally or alternatively, a second timestamp indicating the time at which the first set of decrypted utterances are received/spoken may also be part of the token data. In some embodiments, the system may provide the first set of decrypted utterances 206a-206b to an artificial intelligence model configured to generate embeddings (e.g., an embedding model, a large language model, Word2Vec, GloVE, FastText, ELMo, BERT, RoBERTa, DistilBERT, ALBERT, USE, InferSent, SBERT, CLIP, ALIGN, Multimodal transformers, etc.), and store such generated embeddings as part of the token data. Upon generating the token associated with the first set of decrypted utterances 206a-206b, the system may store the token in the token vault database (not shown) for later retrieval.

In some embodiments, the system may determine one or more tokens. When determining (e.g., retrieving, searching for, identifying, etc.) a set of relevant computer files associated with a live conversation, the system (e.g., system 300) may determine a token based on a subset of tokens. For example, the system may determine a timestamp associated with a set of utterances part of live conversation 202. As the live conversation 202 progresses, user interface 200 may generate transcript 204, which may include first set of decrypted utterances 206a-206b and second set of decrypted utterances 208a-208b. To preserve the context of the live conversation 202 as the live conversation 202 progresses for use in determining a set of relevant computer files to be displayed to a user, the system may determine the timestamp associated with a set of utterances (e.g., second set of decrypted utterances 208a-208b). The system may also retrieve, from a token vault database, a set tokens associated with the live conversation 202. For example, the system may query the token vault database to retrieve a set of tokens that are associated (e.g., have been generated during) the live conversation 202. The system may determine, based on the set of retrieved tokens, a subset of tokens associated with a timestamp that is earlier than the timestamp associated with the set of utterances.

As will be explained later, while the system may provide decrypted utterances (or embeddings thereof) to one or more models during the live conversation 202 to determine relevant computer files, the system may preserve context of the live conversation 202 by providing token data to such models in addition to the latest set of utterances communicated during the live conversation 202. As such, the system may determine a subset of tokens that have been generated earlier than the latest set of utterances communicated during the live conversation 202. By way of example, the system may determine first token 209a (e.g., as the subset of tokens) from a set of stored tokens based on the second set of decrypted utterances 208a-208b being the most up to date set of utterances communicated during the live conversation. The system may then determine a token based on the subset of tokens. For example, because the second set of decrypted utterances 208a-208b are the latest set of utterances, the system may determine one or more tokens (e.g., first token 209a) that is associated with another set of decrypted utterances that were communicated earlier in the live conversation 202 to enhance conversational context when determining relevant computer files to be retrieved or displayed during the live conversation. It should be noted, that although one token is being retrieved in this example as the subset of tokens, that the system may retrieve a plurality of tokens (e.g., that have been generated earlier than the latest set of utterances) as the subset of tokens. By doing so, the system may use a plurality of tokens to provide further contextual information related to the live conversation, thereby enhancing relevant computer file determination and accuracy via preserved conversational context. Additionally or alternatively, the system may determine the latest generated token. For example, the system may determine, based on the subset of tokens, a token that is associated with the latest timestamp respective to the subset of tokens. For example, the system may parse the subset of tokens to determine which token has most recently been generated. The system may then determine the token based on the most recently generated token. By doing so, the system may reduce the utilization of computer processing resources by using a single parameter in which to base the determination of the token on.

In some embodiments, the system may generate one or more new tokens based on previously generated tokens to reduce utilization of computer memory. For example, the system may determine, based on a subset of tokens, a plurality of sets of utterances, where each set of utterances of the plurality of sets of utterances correspond to a respective token of the subset of tokens. For example, to maintain conversational context for determining relevant computer files to the live conversation while also reducing the amount of computer memory used when storing such tokens, the system may generate updated tokens based on the live conversation. As an example, where the subset of tokens include four tokens that have been generated during the live conversation 202, the system may generate a new token that encompasses the token data of the four tokens. In some embodiments, upon generating the new token, the system may replace, delete, or remove the four tokens from the token vault database to preserve computer memory resources.

To do so, the system may determine, based on a subset of tokens, a plurality of sets of utterances, where each set of utterances of the plurality of sets of utterances correspond to a respective token of the subset of tokens. For example, the subset of tokens may be previously generated tokens with respect to prior sets of utterances communicated during the live conversation 202. The system may determine the plurality of sets of utterances by retrieving token data associated with each token of the subset of tokens from the token value database. In one example, the system may retrieve, for each token of the subset of tokens, the embedding corresponding to a set of utterances associated with a respective token of the subset of tokens. The system may then provide the respective embeddings to an artificial intelligence model (e.g., an autoencoder, decoder, etc.) to determine the set of utterances corresponding to the respective embedding. In another example, the system may retrieve the set of utterances directly from the token data itself (e.g., where the token data stores the utterances themselves). In yet another example, the system may retrieve the embeddings themselves for use in re-embedding the respective embeddings. In a further example, the system may retrieve the utterances from a database storing the plaintext versions of the utterances in association with the subset of tokens.

The system may then generate a new token based on the subset of tokens. The new token may be generated in a process that is similar, or the same as those outlined above. The new token may include new token data indicating (i) a first token timestamp associated with a token (e.g., of the subset of tokens) having the earlier timestamp respective to the subset of tokens, (ii) a second token timestamp associated with a token (e.g., of the subset of tokens) having the latest/most recent timestamp respective to the subset of tokens, (iii) a new token identifier (e.g., to uniquely identify the new token), and (iv) an indication of a new set of utterances corresponding to the plurality of sets of utterances (e.g., of the subset of tokens). For example, the indication of a new set of utterances may be a combination of the utterances respective to the subset of tokens, an embedding of the embeddings indicated in the token data of the subset of tokens, or an embedding of the utterances of the subset of tokens. The system may store the new token in the token vault database. The system may then use the new token in lieu of one or more of the subset of tokens for use in (i) preserving the conversational context of the live conversation and (ii) determining relevant computer files to the live conversation. In some embodiments, as described above, the system may replace, remove, or delete the subset of tokens in response to storing the new token (e.g., representing the tokens of the subset of tokens) in the token vault database. By doing so, the system may conserve computer memory resources utilized when storing context data of the conversation.

In some embodiments, the system may generate tokens based on an amount of utterances. For example, the system may determine an amount of utterances of a set of utterances communicated during the live conversation 202. By way of example, the system may determine that the first set of decrypted utterances 206a-206b include two utterances. In response to determining that the amount of utterances satisfies a threshold amount of utterances (e.g., a predetermined amount of utterances) the system may generate a token corresponding to the set of utterances (and then store the generated token in a token vault database). The amount of utterances may satisfy the threshold amount of utterances where the amount of utterances meets or exceeds the threshold time period. For example, the system may generate first token 209a based on the first set of decrypted utterances 206a-206b satisfying the threshold amount of utterances. By doing so, the system may generate tokens in real time during the conversation to provide up-to-date conversational context information to one or more models. In some embodiments, the system may provide a set of utterances to one or more models based on an amount of utterances satisfying the threshold amount of utterances. For example, as will be explained later, the system may provide the first set of decrypted utterances 206a-206b to an artificial intelligence model to generate one or more queries, subsets of utterances (e.g., keywords), or retrieve a set of computer files based on the first set of decrypted utterances 206a-206b satisfying the threshold amount of utterances. By doing so, the system may facilitate real-time computer file retrieval related to context provided during the live conversation, thereby (i) improving accuracy of relevant computer files retrieved and (ii) enhancing the user experience.

In some embodiments, the system generates tokens based on a time period. For example, the system may determine a first time period associated with utterances communicated during the live conversation 202. By way of example, the system may determine that the first set of decrypted utterances 206a-206b have been communicated over a time period of 30 seconds. In response to determining that the time period satisfies a threshold time period (e.g., a predetermined time period) the system may generate a token corresponding to the set of utterances (and then store the generated token in a token vault database). The time period may satisfy the threshold time period where the time period meets or exceeds the threshold time period. For example, the system may generate first token 209a based on the first set of decrypted utterances 206a-206b being communicated within the time period that satisfies the threshold time period. The system may then provide the generated token to one or more models to facilitate relevant computer-file retrieval. By doing so, the system reduces convolution of conversational context that may be caused by a pause in conversation, thereby enhancing accuracy of determining relevant computer files to the conversation. In some embodiments, the system may provide a set of utterances to one or more models based on the first time period satisfying the threshold time period. For example, as will be explained later, the system may provide the first set of decrypted utterances 206a-206b to an artificial intelligence model to generate one or more queries, subsets of utterances (e.g., keywords), or retrieve a set of computer files based on the first set of decrypted utterances 206a-206b being communicated during the time period satisfying the threshold time period. By doing so, the system may facilitate real-time computer file retrieval related to context provided during the live conversation, thereby (i) improving accuracy of relevant computer files retrieved and (ii) enhancing the user experience.

As discussed above, user interface 200 may include one or more presentation regions 212a-212b to display (or otherwise present) a set of computer files 210a-210d to a user (e.g., first user 102). In some embodiments, only one presentation region may display one or more of the set of computer files 210a-210d. In some embodiments, more than two presentation regions may be present for presenting a set of computer files 210a-210d. For example, presentation regions 212a-212b, may include a main presentation region 212a and an auxiliary presentation region 212b. Main presentation region 212a may be used to display the most relevant computer file of a set of computer files. For example, first computer file 210a may be the most relevant computer file of the set of computer files 210a-210d. Therefore, first computer file 210a may be displayed in main presentation region 212a. Additionally or alternatively, second computer file 210b, third computer file 210c, and fourth computer file 210d may be displayed in auxiliary presentation region 212b. For example, auxiliary presentation region 212b may be used to display less relevant computer files of the set of computer files. In some embodiments, the relevancy of each computer file of the set of computer files 210a-210d may be determined based on one or more similarity values/metrics (e.g., of embeddings of utterances), relevancy values/metrics, ranking values, threshold values, or identified relevant documents, or other methods in accordance with one or more embodiments.

As an example, in a financial services embodiment, a customer and a customer service agent may be discussing how to change contact information associated with a bank account of the customer. During the conversation, as will be explained later, utterances communicated between the customer and customer service agent may be used to retrieve a set of relevant computer files. For example, the system may retrieve one or more help documents that provide instructions on how to change the customers contact information associated with their bank account. The system may further rank (e.g., rank based on relevancy) the one or more help documents and display the most relevant help document in the main presentation region 212a, while the other, less relevant help documents are displayed in the auxiliary presentation region 212b to enable the customer service agent (or in some embodiments, the customer) to view the retrieved help documents during the live conversation. By doing so, the customer service agent is enabled to help assist the customer in real time using automatically retrieved, relevant, documents associated with the utterances communicated during the live conversation.

In some embodiments, a computer file(s) displayed in the main presentation region 212a may appear larger than other computer file(s). For example, first computer file 210a may visually appear larger than second computer file 210b, third computer file 210c, and fourth computer file 210d. Computer file(s) displayed in the auxiliary presentation region 212b may appear smaller than other computer file(s) displayed in main presentation region 212a. By doing so, a user may reference relevant computer files with ease to assist another user during a live conversation. In some embodiments, computer file(s) presented in the auxiliary region may display a subset of information associated with the respective computer file(s) to reduce the amount of visual content displayed on the user interface 200. By doing so, the system may enable a user (e.g., a customer service agent) to focus on one or more portions of another computer file that is deemed more relevant to the live conversation, thereby enhancing the user experience.

In some embodiments, computer file(s) presented in the auxiliary presentation region 212b may be presented in a manner consistent with a relevancy ranking. For example, second computer file 210b may appear at the top of a stack as second computer file 210b may be more relevant than third computer file 210c and fourth computer file 210d. In some embodiments, user interface 200 may enable a user to select one or more of the computer files being presented within the presentation regions 212a-212b. For example, a user may select first computer file 210a to see an expanded view (e.g., a larger view) of first computer file 210a. As another example, a user may select third computer file 210c to see an expanded view of third computer file 210c. In some embodiments, when a user selects a computer file from the auxiliary presentation region, the selected computer file may replace a current computer file being displayed in the main presentation region. For example, if a user selects fourth computer file 210d from auxiliary presentation region 212b, fourth computer file 210d may replace first computer file 210a being presented in main presentation region 212a to enable the user to view an expanded view of fourth computer file 210d. By doing so, a user (e.g., a customer service agent) may view computer files that may have initially been deemed not as relevant as other computer files in an expanded view to assist another user (e.g., a customer)—thereby enhancing the user experience.

In some embodiments, a computer file may be displayed for a given time period. For example, as the live conversation 202 progresses and the system determines one or more relevant computer files to be displayed, the system may present computer files for a first time period. For example, the first time period may be a predetermined time period (e.g., 30 seconds, one minute, two minutes, etc.) or may be a dynamic time period. For example, the dynamic time period may be based on determining that a more relevant computer file is determined (e.g., a higher ranked computer file with respect to current computer files being displayed, another computer file is determined to be relevant to the conversation, etc.). By way of example, the system may retrieve (e.g., based on one or more computer file identifiers, a similarity value/metric, a relevancy value/metric, etc.) a computer file. The system may then generate for display, on the user interface (e.g., user interface 200), the computer file during the live conversation 202 for the first time period. For instance, the first computer file 210a may be displayed in the main presentation region 212a until another document (e.g., not shown) is determined by the system to be more relevant than first computer file 210a, where the system may replace the display of the first computer file 210a with the other document. By doing so, the system ensures that users are presented with the most relevant computer files to the conversation, thereby enhancing the user experience.

In some embodiments, the system may display a placeholder computer file. To reduce inundating users (e.g., first user 102) with irrelevant information (e.g., computer files) during the conversation, the system may display a placeholder computer file during instances where utterances communicated during the conversation are irrelevant, or otherwise not associated with any computer files stored in a database hosting computer files that can be retrieved. For example, the conversations may include phatic expressions (e.g., utterances, phrases, etc.) that may not be relevant to a purpose of a conversation. Phatic expressions may refer to social functions of language, and may include utterances such as “hi,” “hello,” “how are you,” “goodbye,” “it was great talking to you” or other expressions/phrases that are not relevant to the main purpose of a dialogue, but rather serve as introductions, closings, filler phrases, greetings, politeness routines, casual remarks, or acknowledgements. In the context of determining relevant computer files for a conversation, such phatic expressions may inundate users with irrelevant computer files being displayed during the live conversation, which may cause confusion or decrease the user experience (e.g., due to a large amount of irrelevant computer files being displayed). As such, the system may display a placeholder computer file when such phatic expressions are detected. For example, the system may detect (e.g., via one or more models, natural language processing models, embedding models, etc.) that a phatic utterance/phrase is communicated during the live conversation. In response to detecting (or otherwise determining) a phatic utterance is communicated during the live conversation, the system may display a placeholder computer file on user interface 200.

For example, a placeholder computer file may be an empty computer file (e.g., a null computer file), a blank document, or a default computer file. In some embodiments, the placeholder computer file may be displayed on user interface 200 when a phatic expression is detected. In other embodiments, the placeholder computer file may be displayed only when there has not been another computer file determined to be relevant to the conversation prior to the phatic expression being detected. As an example, first set of decrypted utterances 206a-206b may be phatic expressions/utterances. Initially, the system may display the placeholder document (e.g., in main presentation region 212a) during the live conversation 202 to be presented to a user. Second set of decrypted utterances 208a-208b may represent non-phatic expressions/utterances. Upon the system determining one or more relevant computer files to be displayed that are related to second set of decrypted utterances 208a-208b (e.g., set of computer files 210a-210d), the system may replace the placeholder document with one or more of the relevant computer files. However, if another phatic expression/utterance is detected subsequent to the most recently presented relevant computer files being displayed (e.g., set of computer files 210a-210d), then the system may forego displaying the placeholder computer file in lieu of leaving the most recently presented relevant computer files being displayed.

The user interface may also include one or more data fields or buttons relevant to determining computer files relevant to a live conversation. For example, user interface 200 may include a search term field for search term 214 and a search button 216. Search term field may be a data field configured to accept, as input, one or more queries or other search terms related to determining computer files. Search button 216 may be a user interface element that enables or otherwise facilitates search of computer files. In some embodiments, search term field may be automatically populated with one or more determined or user-provided queries, search terms, keywords, or other textual information, in accordance with one or more embodiments. Search button 216 may be used to enact a search on one or more databases based on data within the search term field. For example, a user may select search button 216 to query the one or more databases based on a query of search term field. In some embodiments, a user may input data into search term field. However, in other embodiments, one or more models (e.g., as described herein) may generate or otherwise determine a query (or other keywords) that may be used to search the one or more databases (not shown). For example, an artificial intelligence model may generate a query based on utterances communicated during the live conversation 202, and may populated the generated query into the search term field. By doing so, not only may queries be automatically generated based on the live conversation 202, but users may have the opportunity to modify the query prior to facilitating a search for one or more computer files-thereby enhancing the user experience. Additionally or alternatively, the search may be facilitated automatically. For example, as opposed to requiring a user selection of search button 216, the system may automatically facilitate the search using the data in search term field-further enhancing the user experience. In other embodiments, the data (e.g., query) generated for search term field may be presented for a threshold amount of time (e.g., 1 second, 5 seconds, etc.) prior to automatically effectuating a search, thereby enabling users the opportunity to modify the generated query, in accordance with one or more embodiments. In some embodiments, upon effectuating the search, a set of computer files 210a-210d may be displayed via the user interface 200 determined to be relevant to the live conversation 202 based on the data inputted or populated into the search term field, in accordance with one or more embodiments.

FIG. 3 shows illustrative components for a system used to facilitate information retrieval during a live conversation, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. In some embodiments, mobile device 322 may correspond to first user device 104 (FIG. 1). In some embodiments, user terminal 324 may correspond to second user device 108 (FIG. 1). FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. As another example, cloud components 310 may operate as a server system that may perform one or more operations as described herein. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational responses, queries, search results, search terms, utterances, transcripts, computer files, user interfaces, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include one or more components of environment 100 (FIG. 1) or user interface 200 (FIG. 2). For instance, cloud components 310 may include a server that performs one or more operations related to determining, retrieving, identifying, or displaying computer files associated with a conversation, in accordance with one or more embodiments.

Cloud components 310 may access one or more databases. For example, cloud components 310 may include one or more databases (or otherwise access one or more databases) such as a token vault database (e.g., storing one or more tokens, token data, timestamps, token identifiers, pointers to utterances, utterance embeddings, or other token-related information), a system database (e.g., storing decrypted utterances, timestamps, progenerated queries, graphical representations of computer files, public/private keys, threshold values, metrics, error indications, embeddings, user identifiers, embedding spaces, subsets of utterances, keywords, or other system information, LLM prompts), a computer file database (e.g., storing one or more computer files, embeddings of computer files, etc.), model database (e.g., storing one or more artificial intelligence models such as LLMs, neural networks, bifurcated models, secured models, encoders, decoders, audio-to-text models, text-to-audio models, document rankers, relevancy evaluation models, natural language processing models, or other artificial intelligence models), model training databases (e.g., storing training data for artificial intelligence models, positive and negative examples, labeled data, or other model training data), or other databases, in accordance with one or more embodiments.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., a query, a subset of utterances, one or more keywords, a computer file identifier, relevancy values, relevancy error, an utterance embedding, a computer file embedding, etc.).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, the model (e.g., model 302) may be a secured model. For instance, the secured model may be secured in a secured computing environment that is protected via one or more firewalls, antivirus software, encryption protocols, intrusion detection and prevention systems, authentication mechanisms, or the like. For example, system 300 may indicate a secure computing environment. By doing so, the system may provide a secure environment for training or using secured models-thereby mitigating the risk of malicious obtainment of proprietary data. In some embodiments, the model (e.g., model 302) may comprise a Large Language Model (LLM). In some embodiments, the model may comprise a bifurcated model (e.g., a model comprising two or more sub-models, a model comprising one or more model portions, a model comprising one or more layer sets (e.g., sets of layers each configured for a given purpose, etc.).

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., a query, a subset of utterances, one or more keywords, a computer file identifier, relevancy values, relevancy error, an utterance embedding, a computer file embedding, etc.).

In some embodiments, the model (e.g., model 302) may automatically perform actions based on outputs 306. In some embodiments, the model (e.g., model 302) may not perform any actions. The output of the model (e.g., model 302) may be used to perform a search on a database, identify a set of computer files, display a set of computer files, provide sets of utterances to the model, retrieve a token, generate a token, or other actions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

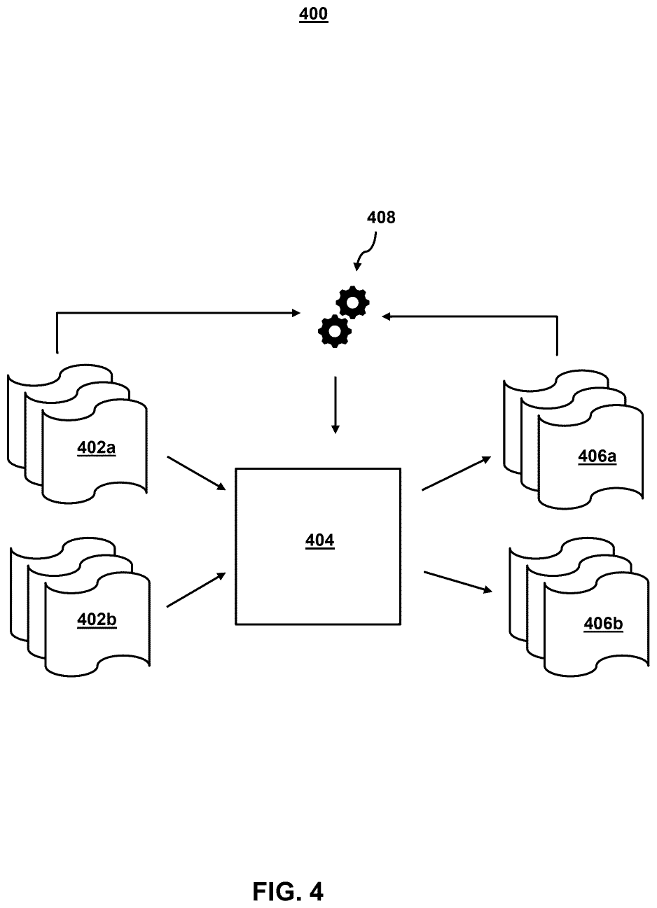

FIG. 4 shows an illustrative diagram of an artificial intelligence model used to facilitate one or more operations, in accordance with one or more embodiments. For example, diagram 400 shows an artificial intelligence model 404, which may correspond to model 302 (FIG. 3). In some embodiments, artificial intelligence model 404 (hereinafter, model 404) may be a secured model, such as an LLM implemented in a secure computing environment. Diagram 400 shows input data 402a-402b and output data 406a-406b. Diagram 400 also shows training routine component 408 which may indicate a user-provided input related to training or otherwise fine tuning the model 404 during a training routine. In some embodiments, input data 402a-402b may be split into two portions. For example, first input data portion 402a may represent utterances and second input data portion 402b may represent token data. Each of first input data portion 402a and second input data portion 402b may be associated with utterances. Consistent with one or more embodiments, first input data portion 402a may include utterances, such as decrypted utterances, natural language utterances, or training utterances (e.g., for use during a training routine), embeddings of utterances, or other information associated with utterances (e.g., timestamps), and second input data portion 402b may include token data of one or more tokens, such as token identifiers, timestamps, embeddings of utterances associated with the token, utterances associated with the token, or other token-related data. Model 404 may be configured to generate output data 406a-406b based on input data 402a-402b. For example, output data 406a-406b may be split into two portions. For example, first output data portion 406a may represent one or more queries, and second output data portion 406b may represent one or more subsets of utterances. For instance, first output data portion 406a may represent a query that model 404 generates based on input data 402a-402b, while second output data portion 406b indicates one or more utterances (e.g., keywords) based on input data 402a-402b.

In the context of determining a set of computer files relevant to a conversation (e.g., live conversation 202 (FIG. 2)), the system may employ model 404 to receive, as input, a set of utterances or token data (e.g., representing one or more prior utterance-related data) to generate a query and a subset of utterances. For example, the query may be used to perform a first search on a first database, and the subset of utterances may be used to perform a second search on a second database. For instance, model 404 may be configured to generate (i) a query and (ii) a set of keywords related to utterances communicated during a live conversation to search one or more databases for computer files that are relevant to the live conversation. In some embodiments, the set of keywords may be a filtered set of keywords based on the input data, where, the keywords represent a filtered set of utterances communicated during the live conversation, and where no keyword is duplicated—thereby reducing the amount of computer processing resources used to perform a search, while avoiding convolution of the context of the live conversation. In some embodiments, model 404 may perform tokenization, context analysis, part-of-speech-tagging, semantic scoring, filtering, and/or keyword selection to generate the set of keywords, in accordance with one or more embodiments. In some embodiments, model 404 may be fine-tuned (e.g., as explained later) to generate the query and/or the subset of utterances (e.g., keywords).

As discussed above, output data 406a-406b may be used to perform a first search on a first database, and a second search on a second database. For example, first output data portion 406a may be used to perform a semantic search on the first database, and the second output data portion 406b may be used to perform a lexical search on the second database. In some embodiments, the first database and the second database may be different databases respectively configured for a semantic or lexical search, yet store the same information (e.g., computer files). In some embodiments, however, the first database and the second database may be the same database, yet configured to facilitate both semantic and lexical searches (e.g., for computer files, relevant computer files, etc.). The first and second databases may be associated with an entity. For example, the entity may refer to a company, merchant, service provider, person, or other entity that controls or otherwise has access to the one or more databases. For example, the first and second databases may be part of a financial service provider (e.g., a bank) which stores computer files related to banking data, customer account information, help documents, or other entity data. In some embodiments, as will be explained later, search results from each of the first search and the second search may be returned to the system (e.g., system 300) and be further processed to display the most relevant computer files associated with the live conversation.

In some embodiments, model 404 may be trained. For example, model 404 may be trained during a training routine. The model 404 may be trained on a set of training data by fine tuning model 404. The set of training data may include (i) a set of training transcripts comprising a plurality of sets of utterances and (ii) a prompt indicating to generate a query based on one or more of the sets of utterances included in the plurality of sets of utterances. The set of utterances part of the plurality of sets of utterances of the training transcripts may each be labeled with (i) a target query, (ii) a target subset of utterances, or (iii) a user identifier indicating a user that spoke (or otherwise communicated) the set of utterances of the plurality of utterances.

For example, in some embodiments, each training transcript may include a plurality of sets of utterances, where each set of utterances of the plurality of sets of utterances are labeled with (i) a user identifier indicating a user who spoke a respective set of utterances, (ii) a target query to be generated based on the respective set of utterances, and (iii) a target subset of utterances to be generated based on the respective set of utterances. By using the user identifier labels in conjunction with the set of utterances, target query, and target subset of utterances, the system may provide further contextual information to the model during the training routine, such that the model learns the difference between a customers ask and a customer service agents ask. For instance, while a customer service agent may be helping a customer solve a given problem, typically the customer service agent is communicating redundant information that the customer service agent has found, or, is asking questions to help flesh out a problem the customer is having. Therefore, in order to generate accurate queries and subsets of utterances keyed to solving a problem the customer is currently facing, the system may use labels indicating user identifiers to focus generation of the queries and subsets of utterances to utterances or phrases that the customer is communicating. By doing so, the system may generate more accurate queries and subsets of utterances keyed to solving a problem or other inquiry of the customer, as opposed to convoluting the conversational context during the live conversation caused by the customer service agent's utterances.

The set of training data may be obtained from a model training database (e.g., as described above). For example, the system may retrieve the set of training data from the model training database in response to determining the model (e.g., model 404) to be trained. The system may provide the set of training data as input to model 404 during the training routine, and model 404 may generate candidate outputs indicating a generated query (e.g., first output data portion 406a) and a generated subset of utterances (e.g., second output data portion 406b). During the training routine, model 404 may learn the relationships between the inputs (e.g., utterances part of the training transcripts, user identifiers associated with the utterances) and the outputs (e.g., target queries and target subsets of utterances). For example, model 404 may generate candidate queries and candidate subsets of utterances based on the inputs. During the training routine, model 404 may adjust one or more parameters of model 404 to reduce a loss between the candidate queries and candidate subsets of utterances with respect to the target queries and target subsets of utterances for a respective input. In some embodiments, the system may receive, from model 404 during the training routine, based on the set of training transcripts, the set of candidate queries and the set of candidate subsets of utterances. Using the candidate queries and candidate subsets of utterances, the system may fine tune model 404.

Fine-tune training (or fine tuning) refers to a training method where a pre-trained (or partially trained) artificial intelligence is adapted for a specific task or use case. For example, fine-tuning may involve a user providing additional information (e.g., labels, indication of accuracy, prompts etc.) to a model (e.g., model 404) to generate more accurate, contextualized, domain specific responses from the model. For instance, with respect to the above, a user may provide, via user interface 200, a message to model 404 that includes an accuracy value corresponding to (i) each candidate query of the set of candidate queries and (ii) each candidate subset of utterances of the set of candidate subsets of utterances that model 404 generated. The accuracy value may be a numerical value, such as a normalized numerical value according to a given scale (0-1, 0-10, 0-100, etc.), a percentage, or other quantitative metric for measuring accuracy. In response to providing the message to the model (e.g., model 404), the system may cause one or more configurations (e.g., weights, biases, or other parameters) of the model to be updated. By doing so, the LLM may be further trained (e.g., fine-tuned) using quantitative accuracy metrics to better predict or generate queries/subsets of utterances to be used in determining relevant computer files associated with a live conversation.

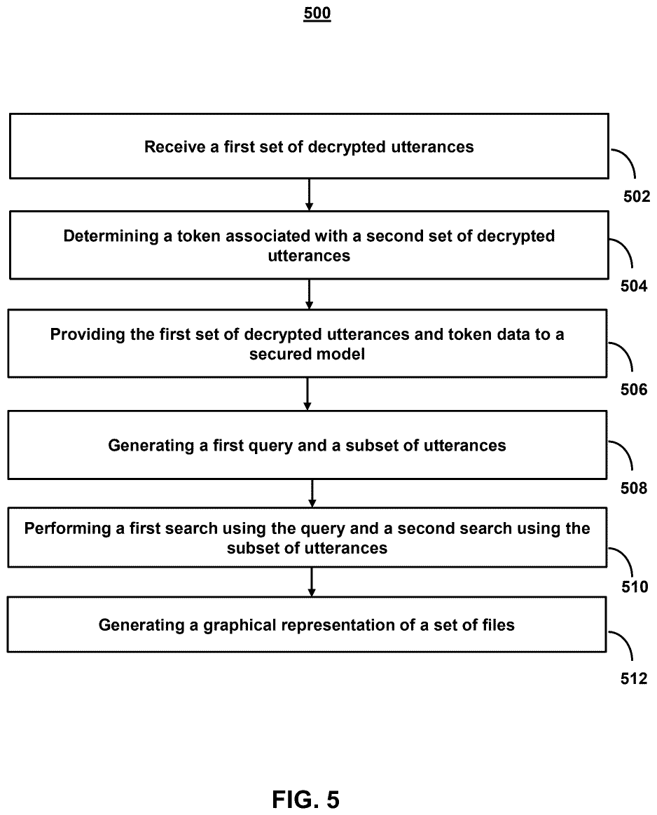

FIG. 5 shows a flowchart of the steps involved in improving information retrieval during a live conversation via context tokens and real-time natural language utterances, in accordance with one or more embodiments. For example, the system may use process 500 (e.g., as implemented on one or more system components described above) to generate queries and subsets of utterances corresponding to utterances communicated during a live conversation to retrieve information from databases.

At step 502, process 500 (e.g., using one or more components described above) may receive a first set of decrypted utterances. For example, the system (e.g., system 300) may receive, during a live conversation over a computer network, a first set of decrypted utterances. For example, the first set of decrypted utterances may be utterances spoken during the live conversation. The first set of decrypted utterances may include natural language utterances spoken within a first time period during the live conversation. For example, the first set of decrypted utterances may be utterances spoken by a first user participating in the live conversation, and a second user participating in the live conversation. In some embodiments, as described above, upon receiving the first set of decrypted utterances, the system may generate a token based on the first set of decrypted utterances and store the generated token in a token vault database for later retrieval.

In a customer service embodiment, the first user may be a customer service agent and the second user may be a customer. The customer service agent and the customer may converse during a live conversation (e.g., via a telephone conference, a video conference, an instant messaging conference, etc.). The customer may be calling to discuss a problem (or other inquiry) that the customer is or has experienced, and the customer service agent may attempt to help resolve the customer's problem. Conventionally, customer service agents may leverage databases of available “help” information. To do so, the customer service agent may query the databases to retrieve relevant computer files (or other documents) to assist the customer. However, because the customer service agent is engaged in a conversation, it may be difficult to create queries on-the-fly, and the customer service agent may miss or otherwise misinterpret what the customer is communicating-thereby leading to ineffective queries. This in turn causes an increased amount of computational resources to be utilized when ineffective or otherwise incorrect queries are created and used to search databases due to (i) a large amount of queries being submitted to the databases from ineffective queries and (ii) the computing systems returning irrelevant documents to the customer's problem. To overcome this, however, the system may first receive a set of utterances (e.g., portions of words, sounds, or other conversational elements) and use the set of utterances to generate one or more queries and subsets of utterances (e.g., keywords), thereby alleviating the customer service agent from the problems outlined above-thereby enhancing the user experience of both the customer and the customer service agent.

In some embodiments, the system may generate the first set of decrypted utterances. For example, the system may receive, during the live conversation, from a user device of a user, a first set of encrypted utterances. The first set of encrypted utterances may be encrypted via a first encryption protocol using a public key associated with another user device (e.g., a receiving device). For example, the first encryption protocol may be an asymmetric encryption protocol to enhance cybersecurity of the conversation. The system may decrypt the first set of encrypted utterances via a private key associated with the other user device. The system may generate the first set of decrypted utterances based on the decrypted first set of encrypted utterances and a second set of decrypted utterances.

For example, the second set of decrypted utterances may be utterances communicated by the other user device (e.g., the receiving device). For example, the user device of the user may be a customer's user device, and the other user device (e.g., the receiving device) may be that of a customer service agent. Because the other user device may be part of an entity's computing system used to determine a set of relevant computer files to aid the user (e.g., the customer), the system need not encrypt the utterances communicated by the customer service agent to generate the first set of decrypted utterances-thereby conserving computational resources that would otherwise be wasted when encrypting the utterances communicated by the customer service agent, just to be decrypted to generate the first set of decrypted utterances (e.g., to which the system will use to generate the queries and subsets of utterances, as explained later). As such, the system may generate the first set of decrypted utterances by combining or aggregating the decrypted first set of encrypted utterances and the second set of decrypted utterances. In some embodiments, however, the system may encrypt the second set of decrypted utterances to be sent to the user device (e.g., the customer's device) to facilitate the real-time conversation.

In some embodiments, the system may generate the first set of decrypted utterances based on an artificial intelligence model. For example, the system may receive, during the live conversation, a first set of encrypted utterances. In such an example, the first set of encrypted utterances may be natural language utterances spoken by a first user (e.g., a customer service agent) and a second user (e.g., a customer). For instance, the first set of encrypted utterances may be encrypted using a first encryption protocol. In such an example, the first set of encrypted utterances may be audio data of utterances spoken by the first and second user. To generate one or more queries or subsets of utterances corresponding to the utterances spoken during the live conversation, the system may provide the audio data of the utterances to a second secured model, trained to decrypt encrypted spoken utterances, to generate the first set of decrypted utterances. For example, the second secured model may be an audio-to-text model that is part of a secured computing system (e.g., system 300 (FIG. 3)). By doing so, the system may transform the audio data of utterances communicated during the live conversation to a text format to be provided to one or more models configured to generate queries or subsets of utterances. Additionally, as existing information retrieval systems are not currently configured to accept real-time conversation information, the system may perform real time (or near-real time) batch generation of converted audio data to be provided to such models—thereby reducing information retrieval latency.

At step 504, process 500 (e.g., using one or more components described above) may determine a token associated with a second set of decrypted utterances. For example, the system (e.g., system 300) may determine, from a token vault database, a token comprising token data associated with a second set of decrypted utterances spoken during the live conversation. The second set of decrypted utterances may be utterances that were spoken during the live conversation prior to when the first set of decrypted utterances were received. For instance, the system may retrieve a token from the token vault database that is associated with a set of utterances spoken prior to the current set of utterances received by the system (e.g., first set of decrypted utterances). The token, for example, may include token data including an embedding of a set of utterances and a timestamp at which the respective set of utterances were communicated during the live conversation (or alternatively, a time at which the respective token was generated). In some embodiments, the token may include token data including the set of utterances themselves (e.g., in plaintext format). The system may determine the token via a variety of methods as described above. By doing so, the system may overcome context window limitations associated with existing systems by retrieving tokenized representations of historical utterances to supplement topics or ideas currently being discussed during the live conversation.

For example, referring to FIG. 2, where the first set of decrypted utterances correspond to the second set of decrypted utterances 208a-208b, the system may determine a first token 209a, which may include an embedding of the first set of decrypted utterances 206a-206b. In other words, the system may determine a token indicating a prior set of utterances spoken during the live conversation. By doing so, as will be explained later, the system may determine conversational context tokens to be provided to a secured model to generate one or more queries or subsets of utterances-thereby preserving earlier context of the conversation to retrieve relevant computer files associated with the live conversation.

At step 506, process 500 (e.g., using one or more components described above) may provide the first set of decrypted utterances and token data to a secured model. For example, the system (e.g., system 300) may provide (i) the first set of decrypted utterances and (ii) the token data as input to a secured model, trained to generate first outputs indicating queries and second outputs indicating subsets of natural language utterances. For example, the secured model (e.g., model 404 (FIG. 4)) may be a LLM implemented in a secure computing environment. For instance, the secured model may be configured to receive sets of utterances or embeddings of utterances as input data, and may be configured to generate one or more queries or subsets of utterances related to the input data as output data. The LLM may be configured to generate, simultaneously (or near-simultaneously), both the generated query and the subset of utterances. By doing so, the system may reduce information retrieval latency by using a model configured to generate both the queries and subset of utterances at the same time. Furthermore, by doing so, the system provides a dual approach for retrieving a relevant set of computer files related to the live conversation by facilitating a two dimensional search at the same time—further reducing information retrieval latency while increasing information retrieval accuracy using the two dimensional search configuration. Additionally, contrary to existing systems that may use LLMs to retrieve information itself, the LLM described herein is configured to generate the query and subset of utterances. By doing so, the system mitigates the risk of LLM-derived hallucinations and rather focuses on generating the queries and subsets of utterances themselves to search databases storing trusted and factually accurate information.

As an example, the system may provide the first set of decrypted utterances and token data (e.g., indicating the second set of utterances as part of the respective determined token) as input to generate (i) a first query and (ii) a subset of natural language utterances as output. In some embodiments, the secured model may receive a set of utterances without token data as input. For example, in instances where it is determined that there is no token generated prior to the system receiving a current set of utterances, the system may provide solely the current set of utterances (e.g., the first set of decrypted utterances) communicated during the live conversation as input to the secured model to generate a query and a subset of utterances related to the current set of utterances.

The query generated as output may be a query relating to (i) the first set of decrypted utterances or (ii) the token data (e.g., indicating the second set of utterances as part of the respective determined token). For example, referring to FIG. 2, in a customer service embodiment, the LLM may be configured to generate a query based on utterances spoken during the live conversation. For example, where a customer and a customer service agent are discussing how to diagnose an internet connection issue, the system may provide second set of decrypted utterances 208a-208b and token data of first token 209a as input to the LLM to generate a query (e.g., search term 214). The token data of first token 209a may include an embedding of the first setoff decrypted utterances 206a-206b, or may include the first set of decrypted utterances 206a-206b themselves. In such an example, the system may generate, via the LLM, the query (e.g., search term 214). As will be explained, the generated query may be used to perform a first search on a first database (e.g., a semantic search using the generated query) to retrieve a relevant set of computer files corresponding to utterances communicated during the live conversation.

The subset of utterances generated as output may be a set of keywords relating to (i) the first set of decrypted utterances or (ii) the token data (e.g., indicating the second set of utterances as part of the respective determined token). For example, continuing with the example above, the LLM may be configured to also generate a set of keywords based on utterances spoken during the live conversation. Although not shown, the system may generate, via the LLM, a set of keywords that include one or more utterances of (i) the first set of decrypted utterances or (ii) utterances indicated in the token data. For example, where the first set of decrypted utterances indicate “My computer says it is not connected to the Internet. Ok, first turn off your computer,” the LLM may generate a set of keywords indicating “Computer,” “not,” “connected,” “Internet.” The set of keywords may include a set of words, phrases, or other utterances that are (i) each different from each other keyword (e.g., avoiding duplicates) and (ii) embody the context of the respective utterances provided as input to the LLM. As will be explained, the generated subset of utterances may be used to perform a second search on a second database (e.g., a lexical search using the generated subset of utterances) to retrieve a relevant set of computer files corresponding to utterances communicated during the live conversation.

At step 508, process 500 (e.g., using one or more components described above) may generate a first query and a subset of utterances. For example, in response to providing the first set of decrypted utterances as input to the secured model (or the token data), the system (e.g., system 300) may generate, via the secured model, (i) the first query corresponding to both the first set of decrypted utterances and the token data and (ii) the subset of utterances corresponding to the first set of decrypted utterances and the token data. For example, as described above, the secured model (e.g., the LLM) may focus on generating the query and the set of keywords corresponding to the utterances communicated during the live conversation to be used to search for a set of relevant computer files to be displayed to a user during the live conversation. By doing so, the system enhances the user experience as users need not focus on generating effective queries (or keywords) themselves, but may rather continue the conversation in natural form to further enhance understanding of another user's inquiry or problem at hand.

In some embodiments, to aid generation of the first query and the subset of utterances, the system may populate one or more predetermined prompts. For example, where the secured model is an LLM, the system may populate a predetermined LLM prompt with one or more instructions that guide the LLM to generate the first query and the subset of utterances (e.g., keywords) based on the first set of decrypted utterances or the token data indicating a set of previously communicated utterances. For example, the predetermined prompt may include a header instruction such as “Generate a query and a set of keywords based on the information provided below:” as well as input data fields configured to receive the first set of decrypted utterances or the token data. For example, the system may populate the predetermined prompt with the first set of decrypted utterances and the token data (e.g., indicating the set of previously communicated utterances) to the predetermined prompt. The system may provide the populated prompt to the LLM to generate the query and the subset of utterances. By doing so, the LLM may be provided with guiding instructions on which data to base generation of the query and subsets of utterances on.

In some embodiments, the subset of utterances may indicate the most frequent utterances communicated during the live conversation. For example, as the system may leverage both (i) current utterances being communicated during the live conversation and (ii) historical utterances previously communicated during the live conversation (e.g., obtained via one or more tokens), the system may generate the subset of utterances such that the subset of utterances reflect the most frequently communicated utterances mentioned during the live conversation. For example, the system may determine, based on multiple sets of subsets of utterances generated via the secured model, a frequency of each utterance. The system may then extract, from the multiple sets of subsets of utterances, a predetermined amount of utterances based on the frequency of the respective utterances. For example, the system may retrieve, from the token vault database, all available tokens generated during the live conversation. The system may then determine, based on the token data associated with such tokens, the utterances that are indicated in the token data. The system may then use (i) the first set of decrypted utterances and (ii) the utterances indicated via the token data of the available tokens to determine a frequency of each utterance. The system may then generate, the subset of utterances to be used in performing the second search, based on the determined frequencies.

As an example, when considering the first set of decrypted utterances and the utterances indicated via the token data of the available tokens, there may exist: 5 instances of the utterance “what,” 30 instances of the utterance “computer,” 25 instances of the utterance “Internet,” 21 instances of the utterance “disconnected,” 14 instances of the utterance “please,” and 12 instances of the utterance “ok.” The system may then extract a predetermined amount of utterances based on a relative frequency. For example, the system may be configured to extract the top 3 most frequent utterances to be used as the subset of utterances (e.g., which will be used to perform the second search). As such, the system may extract the utterances “computer,” “Internet,” and “disconnected” to be used as the subset of utterances. By doing so, the system may reduce the amount of computer memory resources utilized when performing the second search by filtering the amount of data involved with performing the first search. Furthermore, the system may also preserve the historical context of the live conversation as the conversation progresses-thereby enabling the system to retrieve the most contextually-accurate set of computer files for the conversation.

At step 510, process 500 (e.g., using one or more components described above) may perform a first search using the query and a second search using the subset of utterances. For example, the system (e.g., system 300) may perform (i) a first search using the first query on a first database and (ii) a second search using the subset of utterances on a second database to retrieve a set of relevant computer files based on the first search and the second search. The first search and the second search may be performed at the same time. For example, to reduce information retrieval latency, the system may perform the first search on a first database at the same time as the second search on a second database. The first search may be semantic search and the second search may be a lexical search. For example, the first database may be configured for semantic searching, and the second database may be configured for lexical searching, although storing the same or similar information (e.g., sets of computer files, embeddings of computer files, representations of computer files, etc.). By doing so, the system may perform such searches to receive, from the databases, subsets of relevant computer files based on the respective searches-thereby expanding the possibilities of retrieved documents by leveraging different searching methodologies.

In some embodiments, however, the system may perform the first search on the first database at a different time as the second search on the second database. For example, where the first and second databases are the same, the system may wait until the first search is finished being completed prior to the second search to avoid dual requests being transmitted to the respective database at the same time.

In some embodiments, prior to performing the first or second search, the system may prepare the query and the subset of utterances for the respective searches. For example, with respect to the semantic search, the first database may be a vector database and the query by the secured model may be in a natural language format. For example, the first database may store vector embeddings of computer files (e.g., the same computer files) as in the second database. As such, the system (e.g., the secured model) may generate a vector embedding (e.g., embeddings) of generated query to be used in searching the first database configured for a lexical search. By doing so, the system may mitigate errors associated with providing an incompatible data type to the first database to facilitate a semantic search. In some embodiments, however, the generated query (e.g., via the secured model) may be of a vector embedding format-thereby conserving computer processing resources that would otherwise be expended by existing systems leveraging LLM-derived, natural language utterance, output approach.

In some embodiments, the system may retrieve a subset of computer files based on the respective first search and second search. For example, the system may perform a semantic search using the first query on the first database, where the first database is configured to receive a query. In response to performing the semantic search on the first database, the system may receive a first subset of computer files corresponding to the first query. For example, the system may receive, from the first database, a first subset of computer files as search results from performing the first search. In some embodiments, as opposed to receiving the first subset of computer files themselves, the system may retrieve an identifier corresponding to the subset of computer files based on the first search (e.g., to reduce computer memory resource utilization). The system may also perform a lexical search using the subset of utterances on the second database, where the second database is configured to receive one or more utterances. In response performing the lexical search on the second database, the system may receive a second subset of computer files corresponding to the subset of utterances. For example, the system may receive, from the second database, a second subset of computer files as search results from performing the second search. Similarly, as mentioned above, in some embodiments, as opposed to receiving the second subset of computer files themselves, the system may retrieve an identifier corresponding to the subset of computer files based on the second search (e.g., to reduce computer memory resource utilization). The system may then determine (or otherwise retrieve in the case of obtaining identifiers of the computer files), a set of relevant computer files based on (i) the first subset of computer files and (ii) the second subset of computer files.

In some embodiments, to determine (or otherwise retrieve) the set of relevant computer files based on (i) the first subset of computer files and (ii) the second subset of computer files, the system may provide the respective subsets of computer files to an artificial intelligence model. For example, the system may provide (i) the first subset of computer files and the second subset of computer files and (ii) the first query and the subset of utterances as input to the artificial intelligence model. For example, the artificial intelligence model may be a relevancy evaluation model configured to generate computer file relevancy values for computer files based on queries and utterances. For instance, the system may provide the respective subsets of computer files with the first query and the subset of utterances as input to the relevancy evaluation model to determine a relevancy value for each computer file of (i) the first subset of computer files and (ii) the second subset of computer files. For example, the relevancy evaluation model may be a term Frequency-Inverse document frequency model, a best matching 25 model, a vector space model, learning-to-rank models, deep learning models, probabilistic relevance feedback models, or other artificial intelligence model configured to receive the indicated data as input, and provide relevancy values corresponding to computer files as output. For example, the relevancy values may be a numerical value, such as a normalized numerical value according to a given scale (0-1, 0-10, 0-100, etc.), a percentage, or other quantitative metric for measuring computer file relevancy with respect to (i) the first query and (ii) the subset of utterances.

The system may then determine a set of relevant computer files based on the set of relevancy values satisfying a threshold relevancy value. For example, the system may select, among the first subset of computer files and the second subset of computer files, computer files that have a relevancy value satisfying the threshold relevancy value. For example, the threshold relevancy value may be a predetermined relevancy value. A relevancy value may satisfy the threshold relevancy value where the relevancy value meets or exceeds the threshold relevancy value. Upon selecting the computer files that satisfy the threshold relevancy value, the system may retrieve, from the first database or the second database, the set of relevant computer files. By doing so, the system may then display the determined set of relevant computer files on a user interface (e.g., user interface 200) during the live conversation. Additionally or alternatively, the system may then provide the set of relevant computer files to a computer file re-ranker algorithm to generate a set of ranked sets of relevant computer files (which may then be presented to one or more users during the live conversation.)

At step 512, process 500 (e.g., using one or more components described above) may generate a graphical representation of a set of files. For example, the system (e.g., system 300) may generate, for display, on a user interface of a user device, during the live conversation, a graphical representation of the set of relevant computer files. In a customer service embodiment, the system may present a graphical representation of the set of relevant computer files to a customer service agent to aid a customer with an inquiry or problem they are currently facing. For example, referring to FIG. 2, the set of relevant computer files may correspond to the set of computer files 210a-210d. As described above, in some embodiments, the system may display the most relevant computer file (e.g., based on that computer file's relevancy value) of the set of relevant computer files in a main presentation region 212a and the other relevant computer files of the set of relevant computer files in an auxiliary presentation region 212b (e.g., in descending order according to the respective relevancy values, where the computer file displayed on first or on top of the stack is the most relevant computer file of the set of other relevant computer files). By doing so, the system may enable the customer service agent to aid a customer handle a situation the customer is experiencing during the live conversation by being able to reference relevant information to the customer's situation. Furthermore, as the system automatically determines the queries, subsets of utterances, and the relevant computer files, the customer service agent need only focus on the conversation at hand, thereby enhancing the user experience for both the customer service agent and the customer.

In some embodiments, the system may update a set of relevant computer files by performing an updated search. For example, the system may receive a third set of decrypted utterances communicated during the live conversation within a time period subsequent to the first set of decrypted utterances. The system may then determine a token associated with the first set of decrypted utterances (e.g., such as that generated in step 502). The system may then provide the token data of the determined token and the third set of decrypted utterances communicated during the live conversation as input to the secured model to generate (i) a second query corresponding to both the token and the third set of decrypted utterances. the system may then update the set of relevant computer files by performing (i) a second semantic search using the second query on the first database and (ii) a lexical search using the third set of decrypted utterances on the second database. As such, the system may then generate, for display, on the user interface, an updated graphical representation. For instance, the updated graphical representation may be a graphical representation of the updated set of relevant computer files. By doing so, the system may provide updated sets of relevant computer files to the customer service agent as the live conversation progresses, thereby enhancing the user experience as real-time, currently relevant computer files are presented for display.

In some embodiments, the system may fine tune the secured model during the live conversation. For example, in response to generating, for display, the graphical representation of the set of relevant computer files, the system may display a graphical representation of the first query with the graphical representation of the set of relevant computer files. For example, referring to FIG. 2, the system may display search term 214 along with the set of computer files 210a-210d. The system may then receive, via the user interface, during the live conversation, a user update to the first query based on a detected relevancy error. For example, the customer service agent may determine that the set of computer files that the system has determined are not relevant to the live conversation. As such, the user may modify at least a portion of the first query (e.g., search term 214).

In response to modifying the first query, the system may perform (i) an updated first search using the user update to the first query on the first database and (ii) an updated second search using the previously determined subset of utterances on the second database during the live conversation. For example, while the determined subset of utterances may not change (e.g., as they are keywords associated with the conversation), the query may be more complex, and due to the nature of semantic searching, the user update to the first query may impact search results of relevant computer files more than that of the subset of utterances. Therefore, the system may leverage the previously determined subset of utterances to perform an updated second search while using the updated, user-modified query to perform an updated first search on the first database to retrieve an updated set of relevant computer files. The system may then generate, for display, on the user interface of the user device (e.g., first user device 104 (FIG. 1)), a graphical representation of the updated set of relevant computer files.

A user (e.g., the customer service agent), may then provide a user input via the user interface indicating an acceptance or a denial of the updated set of relevant computer files. For example, if the user determines that the updated set of relevant computer files are indeed more relevant to the live conversation, the user may accept (e.g., via a button, or other user interface element) the updated set of relevant computer files. On the contrary, if the user determines that the updates set of relevant computer files are not relevant to the live conversation, the user may deny (e.g., via a button, or other user interface element) the updated set of relevant computer files. Based on the acceptance or denial of the updated set of relevant computer files, the system may generate a message including (i) the user update to the first query, (ii) a set of decrypted utterances (e.g., corresponding to those used to generate the first query and the subset of utterances), or (iii) token data (e.g., corresponding to any used determined tokens used to generate the first query or the subset of utterances). For example, the message may be used to update the secured model during the live conversation. For instance, in response to providing the message to the secured model, the system may cause one or more configurations of the secured model to be updated, during the live conversation based on the message. By doing so, the system may facilitate real time updates to the secured model to enable more accurate determination of relevant computer files as the conversation progresses.

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 5.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method, the method comprising: receiving, during a live conversation over a computer network, a first set of decrypted utterances spoken during the live conversation; determining, from a token vault database, a token comprising token data associated with a second set of decrypted utterances spoken during the live conversation prior to the first set of decrypted utterances being received; providing (i) the first set of decrypted utterances and (ii) the token data as input to a secured model, trained to generate first outputs indicating queries and second outputs indicating subsets of natural language utterances; in response to providing the first set of decrypted utterances as input to the secured model, generating, via the secured model, (i) a first query corresponding to both the first set of decrypted utterances and the token data and (ii) a subset of utterances corresponding to the first set of decrypted utterances and the token data; performing, during the live conversation, (i) a first search using the first query on a first database and (ii) a second search using the subset of utterances on a second database to retrieve a set of relevant computer files based on the first search and the second search; and generating, for display, on a user interface of a user device, during the live conversation, a graphical representation of the set of relevant computer files.
2. The method of any one of the preceding embodiments, further comprising: receiving, during the live conversation, from a first user device of a first user, a first set of encrypted utterances, wherein the first set of encrypted utterances are encrypted via a first encryption protocol using a public key associated with a second user device; decrypting the first set of encrypted utterances via a private key associated with the second user device; and generating the first set of decrypted utterances based on the decrypted first set of encrypted utterances and a second set of decrypted utterances, wherein the second set of decrypted utterances are utterances associated with the second user device of a second user.
3. The method of any one of the preceding embodiments, further comprising: receiving, during the live conversation, a first set of encrypted utterances, wherein the first set of encrypted utterances are spoken utterances encrypted using a first encryption protocol; and generating the first set of decrypted utterances based on providing the first set of encrypted utterances as input to a second secured model trained to decrypt encrypted spoken utterances.
4. The method of any one of the preceding embodiments, wherein determining the token further comprises: determining a timestamp associated with the first set of decrypted utterances; retrieving, from the token vault database, a set of tokens associated with the live conversation, wherein the set of tokens comprise token data indicating (i) a token identifier, (ii) a token timestamp, and (iii) a set of decrypted utterances; determining, based on the set of tokens, a subset of tokens associated with a timestamp that is earlier than the timestamp associated with the first set of decrypted utterances; and determining the token based on the subset of tokens.
5. The method of any one of the preceding embodiments, wherein determining the token further comprises: determining, based on the subset of tokens, a plurality of sets of decrypted utterances, where each set of decrypted utterances of the plurality of sets of decrypted utterances correspond to a respective token of the subset of tokens; generating a second token based on the subset of tokens, the second token comprising second token data indicating (i) a first token timestamp associated with a third token having the earliest timestamp respective to the subset of tokens, (ii) a second token timestamp having the latest timestamp respective to the subset of tokens, (iii) a second token identifier, and (iv) a third set of decrypted utterances corresponding to the plurality of sets of decrypted utterances; storing the second token in the token vault database; and determining the token based on second token stored in the token vault database.
6. The method of any one of the preceding embodiments, wherein determining the token further comprises: determining, based on the subset of tokens, a second token having the latest timestamp respective to the subset of tokens; and determining the token based on the second token.
7. The method of any one of the preceding embodiments, wherein the token comprises an embedding of the second set of decrypted utterances.
8. The method of any one of the preceding embodiments, wherein the token comprises the second set of decrypted utterances.
9. The method of any one of the preceding embodiments, wherein the secured model is a Large Language Model (LLM), and wherein the LLM is trained, the training comprising: obtaining a set of training transcripts comprising a plurality of sets of utterances spoken during a conversation between a first user and a second user, wherein each set of utterances of the plurality of sets of utterances is labeled with (i) a target query, (ii) a target subset of utterances, and (iii) a user identifier indicating a user that spoke a respective set of utterances of the plurality of sets of utterances; providing the set of training transcripts to the LLM during a training routine to train the LLM to generate output queries and output subsets of utterances; receiving, from the LLM during the training routine, based on the set of training transcripts, a set of candidate queries and a set of candidate subset of utterances; in response to receiving the set of candidate queries and the set of candidate subset of utterances, providing a message, during the training routine, to the LLM comprising an accuracy value corresponding to (i) each candidate query of the set of candidate queries and (ii) each candidate subset of utterances of the set of candidate subset of utterances; and causing one or more parameters of the LLM to be updated in response to providing the message to the LLM.
10. The method of any one of the preceding embodiments, wherein performing the first search comprises performing a semantic search and wherein performing the second search comprises performing a lexical search, the method further comprising: performing the semantic search using the first query on the first database, wherein the first database is configured to receive a query;
in response to performing the semantic search on the first database, receiving a first subset of computer files corresponding to the first query; performing the lexical search using the subset of utterances on the second database, wherein the second database is configured to receive one or more utterances, in response to performing the lexical search on the second database, receiving a second subset of computer files corresponding to the subset of utterances; and retrieving the set of relevant computer files based on (i) the first subset of computer files and (ii) the second subset of computer files.
11. The method of any one of the preceding embodiments, wherein retrieving the set of relevant computer files further comprises: providing (i) the first subset of computer files and the second subset of computer files and (ii) the first query and the subset of utterances as input to a second secured model configured to generate computer file relevancy values for computer files based on queries and utterances; receiving, from the second secured model, a set of relevancy values corresponding to each computer file of the first subset of computer files and the second subset of computer files; determining the set of relevant computer files based on the set of relevancy values satisfying a threshold relevancy value; and retrieving the set of relevant computer files from the first database or the second database based on the set of relevant computer files satisfying the threshold relevancy value.
12. The method of any one of the preceding embodiments, wherein each utterance of the subset of utterances is different from each other utterance part of the subset of utterances.
13. The method of any one of the preceding embodiments, further comprising: in response to generating, for display, the graphical representation of the set of relevant computer files, generating, for display, on the user interface of the user device, during the live conversation, a graphical representation of the first query with the graphical representation of the set of relevant computer files; receiving, via the user interface, during the live conversation, a user update to the first query based on a detected relevancy error, the user update modifying at least a portion of the first query; in response to modifying the first query, performing (i) an updated first search using the user update to the first query on the first database and (ii) an updated second search using the subset of utterances on the second database, during the live conversation, to retrieve an updated set of relevant computer files based on the updated first search and the updated second search;
generating, for display, on the user interface of the user device, during the live conversation, a graphical representation of the updated set of relevant computer files; in response to receiving, via the user interface, during the live conversation, a user input indicating an acceptance of the updated set of relevant computer files, generating a message comprising (i) the user update to the first query, (ii) the first set of decrypted utterances, and (ii) the token data; and causing one or more parameters of the secured model to be updated, during the live conversation, based on providing the message to the secured model.
14. The method of any one of the preceding embodiments, further comprising: determining an amount of utterances of the first set of decrypted utterances spoken during the live conversation; and in response to determining that the amount of utterances satisfies a threshold amount of utterances, providing (i) the first set of decrypted utterances and (ii) the token data as input to the secured model.
15. One or more non-transitory, computer-readable mediums storing instructions that, when executed by a data processing apparatus, cause the data processing apparatus to perform operations comprising those of any of embodiments 1-14.
16. A system comprising one or more processors; and memory storing instructions that, when executed by the processors, cause the processors to effectuate operations comprising those of any of embodiments 1-14.
17. A system comprising means for performing any of embodiments 1-14.

What is claimed is:

1. A system for improving information retrieval during a live conversation via context
tokens and real-time natural language utterances, the system comprising:
one or more processors and non-transitory computer-readable media storing instructions, that when executed by the one or more processors, perform operations comprising:
receive, during a live conversation between a first user and a second user over a computer network, a first set of decrypted natural language utterances spoken within a first time period during the live conversation;
generating a token comprising token data indicating an embedding of the first set of decrypted natural language utterances with a timestamp indicating a time at which the token is generated;
storing the token in a token vault database;
provide the first set of decrypted natural language utterances as input to a first secured model trained to generate first outputs indicating queries and second outputs indicating subsets of natural language utterances;
in response to providing the first set of decrypted natural language utterances as input to the first secured model, generating, via the first secured model, a first query corresponding to the first set of decrypted natural language utterances and a subset of natural language utterances of the first set of decrypted natural language utterances;
perform (i) a semantic search using the first query on a first database and (ii) a lexical search using the subset of natural language utterances on a second database to retrieve a set of relevant computer files based on both the semantic search and the lexical search;
receive, during the live conversation, a second set of decrypted natural language utterances spoken during the live conversation within a second time period subsequent to the first time period;
providing the token data and the second set of decrypted natural language utterances to the first secured model to generate, via the first secured model, (i) a second query corresponding to both the token and the second set of decrypted natural language utterances and (ii) a second subset of natural language utterances of both the second set of decrypted natural language utterances and the first set of decrypted natural language utterances;
update the set of relevant computer files by performing (i) a second semantic search using the second query on the first database and (ii) a lexical search using the second subset of natural language utterances on the second database; and
generating, for display on a user interface of a user terminal, during the live conversation, a graphical representation of the set of relevant computer files.

2. A method for improving information retrieval during a live conversation via context tokens and real-time natural language utterances, the method comprising:
receiving, during a live conversation over a computer network, a first set of decrypted utterances spoken during the live conversation;
determining, from a token vault database, a token comprising token data associated with a second set of decrypted utterances spoken during the live conversation prior to the first set of decrypted utterances being received;
providing (i) the first set of decrypted utterances and (ii) the token data as input to a secured model, trained to generate first outputs indicating queries and second outputs indicating subsets of natural language utterances;
in response to providing the first set of decrypted utterances as input to the secured model, generating, via the secured model, (i) a first query corresponding to both the first set of decrypted utterances and the token data and (ii) a subset of utterances corresponding to the first set of decrypted utterances and the token data;
performing, during the live conversation, (i) a first search using the first query on a first database and (ii) a second search using the subset of utterances on a second database to retrieve a set of relevant computer files based on the first search and the second search; and
generating, for display, on a user interface of a user device, during the live conversation, a graphical representation of the set of relevant computer files.

3. The method of claim 2, further comprising:
receiving, during the live conversation, from a first user device of a first user, a first set of encrypted utterances, wherein the first set of encrypted utterances are encrypted via a first encryption protocol using a public key associated with a second user device;
decrypting the first set of encrypted utterances via a private key associated with the second user device; and
generating the first set of decrypted utterances based on the decrypted first set of encrypted utterances and a third set of decrypted utterances, wherein the second set of decrypted utterances are utterances associated with the second user device of a second user.

4. The method of claim 2, further comprising:
receiving, during the live conversation, a first set of encrypted utterances, wherein the first set of encrypted utterances are spoken utterances encrypted using a first encryption protocol; and
generating the first set of decrypted utterances based on providing the first set of encrypted utterances as input to a second secured model trained to decrypt encrypted spoken utterances.

5. The method of claim 2, wherein determining the token further comprises:
determining a timestamp associated with the first set of decrypted utterances;
retrieving, from the token vault database, a set of tokens associated with the live conversation, wherein the set of tokens comprise token data indicating (i) a token identifier, (ii) a token timestamp, and (iii) a set of decrypted utterances;
determining, based on the set of tokens, a subset of tokens associated with a timestamp that is earlier than the timestamp associated with the first set of decrypted utterances; and
determining the token based on the subset of tokens.

6. The method of claim 5, wherein determining the token further comprises:
determining, based on the subset of tokens, a plurality of sets of decrypted utterances, where each set of decrypted utterances of the plurality of sets of decrypted utterances correspond to a respective token of the subset of tokens;
generating a second token based on the subset of tokens, the second token comprising second token data indicating (i) a first token timestamp associated with a third token having the earliest timestamp respective to the subset of tokens, (ii) a second token timestamp having the latest timestamp respective to the subset of tokens, (iii) a second token identifier, and (iv) a third set of decrypted utterances corresponding to the plurality of sets of decrypted utterances;
storing the second token in the token vault database; and
determining the token based on the second token stored in the token vault database.

7. The method of claim 5, wherein determining the token further comprises:
determining, based on the subset of tokens, a second token having the latest timestamp respective to the subset of tokens; and
determining the token based on the second token.

8. The method of claim 2, wherein the token comprises an embedding of the second set of decrypted utterances.

9. The method of claim 2, wherein the token comprises the second set of decrypted utterances.

10. The method of claim 2, wherein the secured model is a Large Language Model (LLM), and wherein the LLM is trained, the training comprising:
obtaining a set of training transcripts comprising a plurality of sets of utterances spoken during a conversation between a first user and a second user, wherein each set of utterances of the plurality of sets of utterances is labeled with (i) a target query, (ii) a target subset of utterances, and (iii) a user identifier indicating a user that spoke a respective set of utterances of the plurality of sets of utterances;
providing the set of training transcripts to the LLM during a training routine to train the LLM to generate output queries and output subsets of utterances;
receiving, from the LLM during the training routine, based on the set of training transcripts, a set of candidate queries and a set of candidate subset of utterances;
in response to receiving the set of candidate queries and the set of candidate subset of utterances, providing a message, during the training routine, to the LLM comprising an accuracy value corresponding to (i) each candidate query of the set of candidate queries and (ii) each candidate subset of utterances of the set of candidate subset of utterances; and
causing one or more parameters of the LLM to be updated in response to providing the message to the LLM.

11. The method of claim 2, wherein performing the first search comprises performing a semantic search and wherein performing the second search comprises performing a lexical search, the method further comprising:
performing the semantic search using the first query on the first database, wherein the first database is configured to receive a query;
in response to performing the semantic search on the first database, receiving a first subset of computer files corresponding to the first query;
performing the lexical search using the subset of utterances on the second database, wherein the second database is configured to receive one or more utterances,
in response to performing the lexical search on the second database, receiving a second subset of computer files corresponding to the subset of utterances; and
retrieving the set of relevant computer files based on (i) the first subset of computer files and (ii) the second subset of computer files.

12. The method of claim 11, wherein retrieving the set of relevant computer files further comprises:
providing (i) the first subset of computer files and the second subset of computer files and (ii) the first query and the subset of utterances as input to a second secured model configured to generate computer file relevancy values for computer files based on queries and utterances;
receiving, from the second secured model, a set of relevancy values corresponding to each computer file of the first subset of computer files and the second subset of computer files;
determining the set of relevant computer files based on the set of relevancy values satisfying a threshold relevancy value; and
retrieving the set of relevant computer files from the first database or the second database based on the set of relevant computer files satisfying the threshold relevancy value.

13. The method of claim 2, wherein each utterance of the subset of utterances is different from each other utterance part of the subset of utterances.

14. The method of claim 2, further comprising:
in response to generating, for display, the graphical representation of the set of relevant computer files, generating, for display, on the user interface of the user device, during the live conversation, a graphical representation of the first query with the graphical representation of the set of relevant computer files;
receiving, via the user interface, during the live conversation, a user update to the first query based on a detected relevancy error, the user update modifying at least a portion of the first query;
in response to modifying the first query, performing (i) an updated first search using the user update to the first query on the first database and (ii) an updated second search using the subset of utterances on the second database, during the live conversation, to retrieve an updated set of relevant computer files based on the updated first search and the updated second search;
generating, for display, on the user interface of the user device, during the live conversation, a graphical representation of the updated set of relevant computer files;
in response to receiving, via the user interface, during the live conversation, a user input indicating an acceptance of the updated set of relevant computer files, generating a message comprising (i) the user update to the first query, (ii) the first set of decrypted utterances, and (iii) the token data; and
causing one or more parameters of the secured model to be updated, during the live conversation, based on providing the message to the secured model.

15. The method of claim 2, further comprising:
determining an amount of utterances of the first set of decrypted utterances spoken during the live conversation; and
in response to determining that the amount of utterances satisfies a threshold amount of utterances, providing (i) the first set of decrypted utterances and (ii) the token data as input to the secured model.

16. One or more non-transitory computer-readable media comprising instructions that, when executed by one or more processors, cause operations comprising:
receiving, during a live conversation, a first set of decrypted utterances communicated during the live conversation;
determining a token comprising token data associated with a second set of decrypted utterances communicated during the live conversation prior to the first set of decrypted utterances being received;
providing (i) the first set of decrypted utterances and (ii) the token data as input to a secured model, to generate, via a secured model, (i) a first query and (ii) a subset of utterances;
performing (i) a first search using the first query and (ii) a second search using the subset of utterances to retrieve a set of computer files based on the first search and the second search; and
generating, for display, on a user interface of a user device, a graphical representation of the set of computer files.

17. The media of claim 16, wherein determining the token further comprises:
determining a timestamp associated with the first set of decrypted utterances;
retrieving, from a token vault database, a set of tokens associated with the live conversation, wherein the set of tokens comprise token data indicating (i) a token identifier, (ii) a token timestamp, and (iii) a set of decrypted utterances;
determining, based on the set of tokens, a subset of tokens associated with a timestamp that is earlier than the timestamp associated with the first set of decrypted utterances; and
determining the token based on the subset of tokens.

18. The media of claim 17, wherein determining the token further comprises:
determining, based on the subset of tokens, a second token having the latest timestamp respective to the subset of tokens; and
determining the token based on the second token.

19. The media of claim 16, wherein each utterance of the subset of utterances is different from each other utterance part of the subset of utterances.

20. The media of claim 16, wherein the instructions that, when executed by the one or more processors, further cause operations comprising:
determining an amount of utterances of the first set of decrypted utterances spoken during the live conversation; and
in response to determining that the amount of utterances satisfies a threshold amount of utterances, providing (i) the first set of decrypted utterances and (ii) the token data as input to the secured model.
